(19) United States
(12) Patent Application Publication
(10) Pub. No.: US 2023/0142929 A1
(43) Pub. Date: May 11, 2023

(54) INK SET AND PRINTED ARTICLE

(71) Applicant: FUJIFILM Corporation, Tokyo (JP)

(72) Inventors: Toshiyuki Makuta, Kanagawa (JP); Misato Sasada, Kanagawa (JP); Hiromichi Numazawa, Kanagawa (JP)

(73) Assignee: FUJIFILM Corporation, Tokyo (JP)

(21) Appl. No.: 18/064,937

(22) Filed: Dec. 13, 2022

Related U.S. Application Data
(63) Continuation of application No. PCT/JP2021/022702, filed on Jun. 15, 2021.

(30) Foreign Application Priority Data
Jul. 15, 2020 (JP) 2020-121261

(51) Int. Cl. C09D 11/101; C09D 11/037; C09D 11/107; C09D 11/328; C09B 57/00; B41J 11/00; G06K 7/14

(52) U.S. Cl. CPC C09D 11/101; B41J 11/00216; C09B 57/007; C09D 11/037; C09D 11/107; C09D 11/328; G06K 7/1408

(57) ABSTRACT

Provided are an ink set and a printed article, the ink set comprising an ink jet ink A which contains a polymerizable compound, a photopolymerization initiator, and perylene black and in which a proportion of a polyfunctional polymerizable monomer in the contained polymerizable compound is 60% by mass or more, and an ink jet ink B which contains a polymerizable compound, a photopolymerization initiator, and an infrared absorbing dye and in which a proportion of a polyfunctional polymerizable monomer in the contained polymerizable compound is 60% by mass or more.

### CROSS-REFERENCE TO RELATED APPLICATIONS

This application is a continuation application of International Application No. PCT/JP2021/022702, filed Jun. 15, 2021, the disclosure of which is incorporated herein by reference in its entirety. Further, this application claims priority from Japanese Patent Application No. 2020-121261, filed Jul. 15, 2020, the disclosure of which is incorporated herein by reference in its entirety.

### BACKGROUND OF THE INVENTION

### 1. Field of the Invention

The present disclosure relates to an ink set and a printed article.

### 2. Description of the Related Art

In recent years, studies have been carried out on a technique of manufacturing a printed article by using an ink containing an infrared absorbing material and a polymerizable compound.

For example, JP2018-517001A discloses an ultraviolet-curable infrared transmitting ink composition for an ink jet that does not cause discoloration and deformation even being subjected to a high-temperature heat treatment in the process of curing, drying, and the like, exhibits constant infrared transmittance, surface hardness, and the like, and is enhanced in terms of heat resistance at a high temperature,
the ultraviolet-curable infrared transmitting ink composition for an ink jet containing an organic black pigment selected from the group consisting of perylene black and lactam black or a pigment dispersion liquid containing the organic black pigment,
an acrylic monomer having 4 or more functional groups,
an acrylic monomer having 3 functional groups,
an acrylic monomer having 2 functional groups,
an acrylic monomer having 1 functional group, and
a photoinitiator,
in which the ultraviolet-curable infrared transmitting ink composition for an ink jet has a transmittance of 80% or more at an infrared wavelength of 800 nm or more, and
a change in the transmittance is kept at 1% or less even after the ultraviolet-curable infrared transmitting ink composition for an ink jet is subjected to the high-temperature heat treatment at a temperature of 200° C. or higher.

JP2019-11455A discloses a squarylium compound which has high invisibility, that is, has low absorption in a visible light region (400 nm to 750 nm), has a high near-infrared absorptivity, high light fastness, and has a specific structure as a squarylium compound [A] being unlikely to be aggregated. JP2019-11455A also discloses an ink for an ink jet printer, as an example of an image forming material containing the squarylium compound [A].

### SUMMARY OF THE INVENTION

Incidentally, in recent years, sometimes a printed article has been manufactured which comprises a composite image including a black image and an infrared absorbing image including an overlap portion where the black image and the infrared absorbing image overlap each other in a plane view. Examples of such a composite image include a composite image composed of a black image which is a bar code image and/or a QR code (registered trademark) image and an infrared absorbing image which is a dot code image recorded on the black image.

In some cases, such a printed article is required to satisfy both the readability of the black image in the composite image and readability of the infrared absorbing image in the composite image by infrared rays.

However, in a case where the black image in the composite image is recorded using an ink containing carbon black, sometimes it is difficult to read the infrared absorbing image in the composite image by infrared rays (that is, infrared readability deteriorates.). Because carbon black has absorption in the infrared region, in a case where an attempt is made to read the infrared absorbing image in the composite image by using infrared rays, sometimes not only the infrared absorbing image but also the black image is read, which leads to the above problem.

It is considered that the problem of readability by infrared rays could be solved by recording the black image in the composite image by using an ink containing perylene black which has low absorption in the infrared region.

However, by the studies of the inventors of the present invention and the like, it has been revealed that even in a case where the black image in the composite image is recorded using an ink containing perylene black, sometimes the readability of the infrared absorbing image in the composite image by infrared rays deteriorates.

An object of the present disclosure is to provide a printed article which comprises a composite image including a black image and an infrared absorbing image including an overlap portion where the black image and the infrared absorbing image overlap each other in a plane view, and achieves both the readability of the infrared absorbing image in the composite image by infrared rays and readability of the infrared absorbing image in the composite image by infrared rays, and to provide an ink set suitable for manufacturing the printed article.

Specific means for achieving the above object includes the following aspects.
<1> An ink set comprising an ink jet ink A which contains a polymerizable compound, a photopolymerization initiator, and perylene black and in which a proportion of a polyfunctional polymerizable monomer in the contained polymerizable compound is 60% by mass or more, and an ink jet ink B which contains a polymerizable compound, a photopolymerization initiator, and an infrared absorbing dye and in which a proportion of a polyfunctional polymerizable monomer in the contained polymerizable compound is 60% by mass or more.
<2> The ink set described in <1>, in which the infrared absorbing dye includes a squarylium compound.
<3> The ink set described in <1> or <2>, in which the infrared absorbing dye includes a squarylium compound represented by Formula (1).

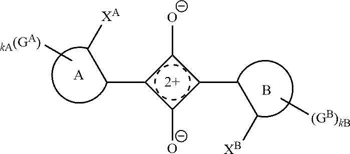

In Formula (1), a ring A and a ring B each independently represent an aromatic ring or a heteroaromatic ring, X^{A} and X^{B} each independently represent a monovalent substituent, G^{A} and G^{B} each independently represent a monovalent substituent, kA represents an integer of 0 to nA, and kB represents an integer of 0 to nB. nA represents an integer which is a maximum number of G^{A}’s capable of substituting the ring A, and nB represents an integer which is a maximum number of G^{B}’s capable of substituting the ring B. X^{A} and G^{A} or X^{B} and G^{B} may be bonded to each other to form a ring, and in a case where there is a plurality of G^{A}’s and a plurality of G^{B}’s, the plurality of G^{A}’s bonded to the ring A may be bonded to each other to form a ring and the plurality of G^{B}’s bonded to the ring B may be bonded to each other to form a ring.

<4> The ink set described in any one of <1> to <3>, in which the ink jet ink A further contains at least one pigment selected from the group consisting of a cyan pigment, a magenta pigment, and a yellow pigment.

<5> ink set described in any one of <1> to <4>, further containing an ink jet ink C which contains a polymerizable compound, a photopolymerization initiator, and a fluorescent substance and in which a proportion of a polyfunctional polymerizable monomer in the contained polymerizable compound is 60% by mass or more.

<6> A printed article comprising a substrate and
a composite image that is disposed on the substrate and includes a black image and an infrared absorbing image including an overlap portion where the black image and the infrared absorbing image overlap each other in a plane view,
in which the black image is a cured substance of an ink jet ink A which contains a polymerizable compound, a photopolymerization initiator, and perylene black and in which a proportion of a polyfunctional polymerizable monomer in the contained polymerizable compound is 60% by mass or more, and
the infrared absorbing image is a cured substance of an ink jet ink B which contains a polymerizable compound, a photopolymerization initiator, and an infrared absorbing dye and in which a proportion of a polyfunctional polymerizable monomer in the contained polymerizable compound is 60% by mass or more.

<7> The printed article described in <6>, in which the infrared absorbing dye includes a squarylium compound.

<8> The printed article described in <6> or <7>, in which the infrared absorbing dye includes a squarylium compound represented by Formula (1).

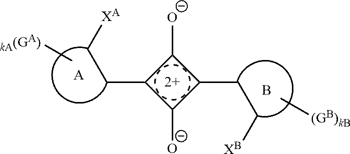

In Formula (1), a ring A and a ring B each independently represent an aromatic ring or a heteroaromatic ring, X^{A} and X^{B} each independently represent a monovalent substituent, G^{A} and G^{B} each independently represent a monovalent substituent, kA represents an integer of 0 to nA, and kB represents an integer of 0 to nB. nA represents an integer which is a maximum number of G^{A}’s capable of substituting the ring A, and nB represents an integer which is a maximum number of G^{B}’s capable of substituting the ring B. X^{A} and G^{A} or X^{B} and G^{B} may be bonded to each other to form a ring, and in a case where there is a plurality of G^{A}’s and a plurality of G^{B}’s, the plurality of G^{A}’s bonded to the ring A may be bonded to each other to form a ring and the plurality of G^{B}’s bonded to the ring B may be bonded to each other to form a ring.

<9> The printed article described in any one of <6> to <8>, in which the ink jet ink A further contains at least one pigment selected from the group consisting of a cyan pigment, a magenta pigment, and a yellow pigment.

<10> The printed article described in any one of <6> to <9>, in which the black image is at least one of a bar code image or a QR code (registered trademark) image, and the infrared absorbing image is a dot code image.

<11> The printed article described in any one of <6> to <10>, in which the composite image further includes at least one color image selected from the group consisting of a cyan image that overlaps the black image in a plane view, a magenta image that overlaps the black image in a plane view, and a yellow image that overlaps the black image in a plane view.

<12> The printed article described in any one of <6> to < 11>, in which the composite image further includes a fluorescence image that overlaps the overlap portion in a plane view, and

the fluorescence image is a cured substance of an ink jet ink C which contains a polymerizable compound, a photopolymerization initiator, and a fluorescent substance and in which a proportion of a polyfunctional polymerizable monomer in the contained polymerizable compound is 60% by mass or more.

According to the present disclosure, there are provided a printed article which comprises a composite image including a black image and an infrared absorbing image including an overlap portion where the black image and the infrared absorbing image overlap each other in a plane view, and achieves both the readability of the infrared absorbing image in the composite image by infrared rays and readability of the infrared absorbing image in the composite image by infrared rays, and an ink set which is suitable for manufacturing the printed article.

### DESCRIPTION OF THE PREFERRED EMBODIMENTS

In the present disclosure, a range of numerical values described using “to” means a range including the numerical values listed before and after “to” as the lower limit and the upper limit.

In the present disclosure, in a case where there is a plurality of substances in a composition that corresponds to each component of the composition, unless otherwise specified, the amount of each component of the composition means the total amount of the plurality of substances present in the composition.

Regarding the ranges of numerical values described stepwise in the present disclosure, the upper limit or the lower limit described in a certain range of numerical values may be replaced with the upper limit or the lower limit of another range of numerical values described stepwise or replaced with the values shown in Examples.

In the present disclosure, the term “step” includes not only an independent step, but also a step that is not clearly distinguished from other steps as long as the step achieves the intended goal.

In the present disclosure, a combination of preferable aspects is a more preferable aspect.

In the present disclosure, “light” is a concept that includes active energy rays such as γ rays, β rays, electron beams, ultraviolet rays, and visible rays.

In the present disclosure, “(meth)acrylate” is a concept that includes both the acrylate and methacrylate, “(meth)acryloyl group” is a concept that includes both the acryloyl group and methacryloyl group, and “(meth)acrylic acid” is a concept that includes both the acrylic acid and methacrylic acid.

In the present disclosure, “image” means a general film formed by the application of an ink on a substrate, and “recording of an image” and “image recording” both mean the formation of a film by the application of an ink on a substrate. The concept of “image” also includes a solid image.

In the present disclosure, “printing” has the same definition as “image recording”.

### Ink Set

The ink set of the present disclosure comprises
an ink jet ink A (hereinafter, also called “ink A”) which contains a polymerizable compound, a photopolymerization initiator, and perylene black and in which a proportion of a polyfunctional polymerizable monomer in the polymerizable compound is 60% by mass or more, and
an ink jet ink B (hereinafter, also called “ink B”) which contains a polymerizable compound, a photopolymerization initiator, and an infrared absorbing dye and in which a proportion of a polyfunctional polymerizable monomer in the polymerizable compound is 60% by mass or more.

The ink set of the present disclosure is suitable for manufacturing a printed article (for example, the printed article of the present disclosure that will be described later) comprising a composite image including a black image and an infrared absorbing image including an overlap portion where the black image and the infrared absorbing image overlap each other in a plane view.

In a case where the aforementioned printed article is manufactured using the ink set of the present disclosure, the readability of the black image in the composite image and the readability of the infrared absorbing image in the composite image by infrared rays (hereinafter, also called “IR readability”) are simultaneously achieved.

The reason why such an effect is obtained is presumed as follows.

According to the ink set of the present disclosure, it is possible to record a black image in the composite image by the ink A containing perylene black, and to record the infrared absorbing image in the composite image by the ink B contained in the infrared absorbing dye.

The ink A contains perylene black which has low absorption in an infrared region. Therefore, in a case where the infrared absorbing image in the composite image is read by infrared rays, a phenomenon where the black image is also read accidentally is suppressed, which brings about the aforementioned effect.

However, by the studies of the inventors of the present invention and the like, it has been revealed that even in a case where the black image in the composite image is recorded using an ink containing perylene black, sometimes the infrared readability of the infrared absorbing image in the composite image deteriorates.

Specifically,
in both the case (1) where the black image in the composite image is recorded using an ink which contains perylene black and in which a proportion of a polyfunctional polymerizable monomer in the polymerizable compound (hereinafter, also called “polyfunctional ratio”) is less than 60% by mass, and
case (2) where the infrared absorbing image in the composite image is recorded using an ink which contains an infrared absorbing dye and has a polyfunctional ratio less than 60% by mass,
sometimes the infrared readability of the infrared absorbing image in the composite image deteriorates.

In the case (1), because the curing properties of the ink containing perylene black are insufficient, bleeding occurs in the infrared absorbing image in the composite image in the process of curing performed until the composite image is obtained, which is considered to result in deterioration of IR readability of the infrared absorbing image.

In the case (2), because the curing properties of the ink containing the infrared absorbing dye are insufficient, bleeding occurs in the infrared absorbing image in the composite image in the process of curing performed until the composite image is obtained, which is considered to result in deterioration of IR readability of the infrared absorbing image.

Regarding this problem, in the ink set of the present disclosure, the polyfunctional ratio in the ink A containing perylene black is 60% by mass or more, and the polyfunctional ratio of the ink B containing the infrared absorbing dye is 60% by mass. Presumably, as a result, the bleeding of the infrared absorbing image in the composite image may be suppressed, which may make it possible to secure the readability of the infrared absorbing image in the composite image by infrared rays. Furthermore, presumably, for the same reason, the bleeding of the black image derived from the ink A containing perylene black may also be suppressed, which may make it possible to secure the readability of the black image in the composite image.

It is considered that for the above reasons, in a case where the aforementioned printed article is manufactured using the ink set of the present disclosure, the readability of the black image in the composite image and the IR readability of the infrared absorbing image in the composite image may be simultaneously achieved.

Preferred aspects of the printed article manufactured by the ink set of the present disclosure will be described in the section of “Printed article” that will be described later.

Hereinafter, the ink A, the ink B, and the like in the ink set of the present disclosure will be described.

### Ink A

The ink A is an ink jet ink which contains a polymerizable compound, a photopolymerization initiator, and perylene black and has a polyfunctional ratio (that is, a proportion of a polyfunctional polymerizable monomer in the contained polymerizable compound) of 60% by mass or more.

### Polymerizable Compound

The ink A contains at least one polymerizable compound.

The polymerizable compound is a compound having a polymerizable group.

As the polymerizable group, a radically polymerizable group or a cationically polymerizable group is preferable, and a radically polymerizable group is more preferable.

The polymerizable compound may have only one polymerizable group or two or more polymerizable groups.

As the polymerizable compound, a radically polymerizable compound (that is, a compound having a radically polymerizable group) is preferable.

The radically polymerizable group is preferably an ethylenically unsaturated group, more preferably at least one radically polymerizable group selected from the group consisting of a (meth)acryloyl group, an allyl group, a styryl group, and a vinyl group, and even more preferably a (meth)acryloyl group.

Examples of the cationically polymerizable group include an epoxy group, an oxetanyl group, and the like.

### Polyfunctional Ratio

In the ink A, a polyfunctional ratio (that is, a proportion of a polyfunctional polymerizable monomer in the polymerizable compound) is 60% by mass or more.

Therefore, the readability of the infrared absorbing image by infrared rays is improved.

The polyfunctional ratio in the ink A may be 100% by mass.

In the present disclosure, the polyfunctional polymerizable monomer means a polymerizable compound which has 2 or more polymerizable groups in one molecule and has a molecular weight of 1,000 or less.

From the viewpoint of further improving the IR readability of the infrared absorbing image, in the ink A, a proportion of a polyfunctional radically polymerizable monomer in the contained polymerizable compound is preferably 60% by mass to 100% by mass.

From the viewpoint of further improving the readability of the infrared absorbing image by infrared rays and the jetting stability of the ink A from an ink jet head, a proportion of a bifunctional radically polymerizable monomer in the polymerizable compound is more preferably 60% by mass to 100% by mass.

The content of the polyfunctional polymerizable monomer (preferably a polyfunctional radically polymerizable monomer, and more preferably a bifunctional radically polymerizable monomer) with respect to the total amount of the ink A is preferably 40% by mass or more, more preferably 50% by mass or more, and even more preferably 60% by mass or more.

The upper limit of the content of the polyfunctional polymerizable monomer (preferably a polyfunctional radically polymerizable monomer, and more preferably a bifunctional radically polymerizable monomer) with respect to the total amount of the ink A is, for example, 95% by mass, although the content depends on the content of other components.

### Polyfunctional Polymerizable Monomer

The ink A contains at least one polyfunctional polymerizable monomer.

As the polyfunctional polymerizable monomer, at least one polyfunctional polymerizable monomer selected from the group consisting of a bifunctional radically polymerizable monomer and a radically polymerizable monomer having 3 or more functional groups is preferable.

Examples of the bifunctional radically polymerizable monomer include bifunctional (meth)acrylate, bifunctional vinyl ether, a bifunctional polymerizable compound containing a vinyl ether group and a (meth)acryloyl group, and the like.

Examples of the bifunctional (meth)acrylate include ethylene glycol di(meth)acrylate, diethylene glycol di(meth)acrylate, triethylene glycol di(meth)acrylate, propylene glycol di(meth)acrylate, dipropylene glycol di(meth)acrylate, tripropylene glycol di(meth)acrylate, polyethylene glycol di(meth)acrylate, polypropylene glycol di(meth)acrylate, butylene glycol di(meth)acrylate, tetraethylene glycol di(meth)acrylate, neopentyl glycol di(meth)acrylate, 3-methyl-1,5-pentanediol di(meth)acrylate, hexanediol di(meth)acrylate, heptanediol di(meth)acrylate, ethoxylated (hereinafter, also described as “EO-modified”) neopentyl glycol di(meth)acrylate, propoxylated (hereinafter, also described as “PO-modified”) neopentyl glycol di(meth)acrylate, EO-modified hexanediol di(meth)acrylate, PO-modified hexanediol di(meth)acrylate, octanediol di(meth)acrylate, nonanediol di(meth)acrylate, decanediol di(meth)acrylate, dodecanediol di(meth)acrylate, 1,6-hexanediol di(meth)acrylate, glycerin di(meth)acrylate, pentaerythritol di(meth)acrylate, ethylene glycol diglycidyl ether di(meth)acrylate, diethylene glycol diglycidyl ether di(meth)acrylate, tricyclodecanedimethanol di(meth)acrylate, 3-methyl-1,5-pentanediol di(meth)acrylate, and the like.

Examples of the bifunctional vinyl ether include 1,4-butanediol divinyl ether, ethylene glycol divinyl ether, diethylene glycol divinyl ether, triethylene glycol divinyl ether, polyethylene glycol divinyl ether, propylene glycol divinyl ether, butylene glycol divinyl ether, hexanediol divinyl ether, 1,4-cyclohexanedimethanol divinyl ether, bisphenol A alkylene oxide divinyl ether, bisphenol F alkylene oxide divinyl ether, and the like.

Examples of the bifunctional polymerizable monomer containing a vinyl ether group and a (meth)acryloyl group include 2-(2-vinyloxyethoxy)ethyl (meth)acrylate.

Examples of the radically polymerizable monomer having 3 or more functional groups include a (meth)acrylate having 3 or more functional groups, a vinyl ether having 3 or more functional groups, and the like.

Examples of the (meth)acrylate having 3 or more functional groups include trimethylolethane tri(meth)acrylate, trimethylolpropane tri(meth)acrylate, EO-modified trimethylolpropane tri(meth)acrylate, PO-modified trimethylolpropane tri(meth)acrylate, pentaerythritol tri(meth)acrylate, pentaerythritol tetra(meth)acrylate, dipentaerythritol tetra(meth)acrylate, dipentaerythritol penta(meth)acrylate, dipentaerythritol hexa(meth)acrylate, tri(meth)acryloyloxyethoxytrimethylolpropane, glycerin polyglycidyl ether poly(meth)acrylate, tris(2-acryloyloxyethyl) isocyanurate, and the like.

Examples of the vinyl ether having 3 or more functional groups include trimethylolethane trivinyl ether, trimethylolpropane trivinyl ether, ditrimethylolpropane tetravinyl ether, glycerin trivinyl ether, pentaerythritol tetravinyl ether, dipentaerythritol pentavinyl ether, dipentaerythritol hexavinyl ether, EO-modified trimethylolpropane trivinyl ether, PO-modified trimethylolpropane trivinyl ether, EO-modified ditrimethylolpropane tetravinyl ether, PO-modified ditrimethylolpropane tetravinyl ether, EO-modified pentaerythritol tetravinyl ether, PO-modified pentaerythritol tetravinyl ether, EO-modified dipentaerythritol hexavinyl ether, PO-modified dipentaerythritol hexavinyl ether, and the like.

From the viewpoint of improving curing properties, the polyfunctional polymerizable monomer is preferably a compound having oxygen atoms.

In the polyfunctional polymerizable monomer which is a compound having oxygen atoms, the ratio of the number of oxygen atoms to the number of carbon atoms contained in one molecule is preferably 0.2 or more, and more preferably 0.3 or more. The upper limit of the ratio is not particularly limited, but is, for example, 0.5. As the compound in which the ratio of the number of oxygen atoms to the number of carbon atoms contained in one molecule is 0.2 or more, 3-methyl-1,5-pentanediol di(meth)acrylate or PO-modified neopentyl glycol di(meth)acrylate is particularly preferable.

The molecular weight of the polyfunctional polymerizable monomer is preferably 800 or less, more preferably 700 or less, and even more preferably 500 or less.

Examples of the lower limit of the molecular weight of the polyfunctional polymerizable monomer include 100 or the like.

### Monofunctional Polymerizable Monomer

The ink A may contain at least one monofunctional polymerizable monomer.

Examples of the monofunctional polymerizable monomer include monofunctional (meth)acrylate, monofunctional (meth)acrylamide, a monofunctional aromatic vinyl compound, monofunctional vinyl ether, and a monofunctional N-vinyl compound.

Examples of the monofunctional (meth)acrylate include methyl (meth)acrylate, ethyl (meth)acrylate, propyl (meth)acrylate, n-butyl (meth)acrylate, hexyl (meth)acrylate, 2-ethylhexyl (meth)acrylate, tert-octyl (meth)acrylate, isoamyl (meth)acrylate, decyl (meth)acrylate, isodecyl (meth)acrylate, lauryl (meth)acrylate, stearyl (meth)acrylate, isostearyl (meth)acrylate, cyclohexyl (meth)acrylate, 4-n-butylcyclohexyl (meth)acrylate, 4-tert-butylcyclohexyl (meth)acrylate, bornyl (meth)acrylate, isobornyl (meth)acrylate, 2-ethylhexyldiglycol (meth)acrylate, butoxyethyl (meth)acrylate, 2-chloroethyl (meth)acrylate, 4-bromobutyl (meth)acrylate, cyanoethyl (meth)acrylate, benzyl (meth)acrylate, butoxymethyl (meth)acrylate, 3-methoxybutyl (meth)acrylate, 2-(2-methoxyethoxy)ethyl (meth)acrylate, 2-(2-butoxyethoxy)ethyl (meth)acrylate, ethyl carbitol (meth)acrylate, 2,2,2-tetrafluoroethyl (meth)acrylate, 1H,1H,2H,2H-perfluorodecyl (meth)acrylate, 4-butylphenyl (meth)acrylate, phenyl (meth)acrylate, 2,4,5-tetramethylphenyl (meth)acrylate, 4-chlorophenyl (meth)acrylate, 2-phenoxymethyl (meth)acrylate, 2-phenoxyethyl (meth)acrylate, glycidyl (meth)acrylate, glycidyloxybutyl (meth)acrylate, glycidyloxyethyl (meth)acrylate, glycidyloxypropyl (meth)acrylate, tetrahydrofurfuryl (meth)acrylate, 2-hydroxyethyl (meth)acrylate, 3-hydroxypropyl (meth)acrylate, 2-hydroxypropyl (meth)acrylate, 2-hydroxybutyl (meth)acrylate, 3-hydroxybutyl (meth)acrylate, 4-hydroxybutyl (meth)acrylate, cyclic trimethylolpropane formal(meth)acrylate, phenylglycidyl ether (meth)acrylate, dimethylaminoethyl (meth)acrylate, diethylaminoethyl (meth)acrylate, dimethylaminopropyl (meth)acrylate, diethylaminopropyl (meth)acrylate, trimethoxysilylpropyl (meth)acrylate, trimethylsilylpropyl (meth)acrylate, polyethylene oxide monomethyl ether (meth)acrylate, polyethylene oxide (meth)acrylate, polyethylene oxide monoalkyl ether (meth)acrylate, dipropylene glycol (meth)acrylate, polypropylene oxide monoalkyl ether (meth)acrylate, 2-methacryloyloxyethyl succinate, 2-methacryloyloxyhexahydrophthalic acid, 2-methacryloyloxyethyl-2-hydroxypropyl phthalate, butoxydiethylene glycol (meth)acrylate, trifluoroethyl (meth)acrylate, perfluorooctylethyl (meth)acrylate, 2-hydroxy-3-phenoxypropyl (meth)acrylate, ethylene oxide (EO)-modified phenol (meth)acrylate, EO-modified cresol (meth)acrylate, EO-modified nonylphenol (meth)acrylate, propylene oxide (PO)-modified nonylphenol (meth)acrylate, EO-modified-2-ethylhexyl (meth)acrylate, dicyclopentenyl (meth)acrylate, dicyclopentenyloxyethyl (meth)acrylate, dicyclopentanyl (meth)acrylate, (3-ethyl-3-oxetanylmethyl) (meth)acrylate, phenoxyethylene glycol (meth)acrylate, and the like.

Among these, monofunctional (meth)acrylate having a cyclic structure is preferable, and cyclic trimethylolpropane formal (meth)acrylate or phenylglycidyl ether (meth)acrylate is particularly preferable.

Examples of the monofunctional (meth)acrylamide include (meth)acrylamide, N-methyl (meth)acrylamide, N-ethyl (meth)acrylamide, N-propyl (meth)acrylamide, N-n-butyl (meth)acrylamide, N-t-butyl (meth)acrylamide, N-butoxymethyl (meth)acrylamide, N-isopropyl (meth)acrylamide, N-methylol (meth)acrylamide, N,N-dimethyl (meth)acrylamide, N,N-diethyl (meth)acrylamide, (meth)acryloylmorpholine, and the like.

Examples of the monofunctional aromatic vinyl compound include styrene, dimethylstyrene, trimethylstyrene, isopropylstyrene, chloromethylstyrene, methoxystyrene, acetoxystyrene, chlorostyrene, dichlorostyrene, bromostyrene, vinyl benzoic acid methyl ester, 3-methylstyrene, 4-methylstyrene, 3-ethylstyrene, 4-ethylstyrene, 3-propylstyrene, 4-propylstyrene, 3-butylstyrene, 4-butylstyrene, 3-hexylstyrene, 4-hexylstyrene, 3-octylstyrene, 4-octylstyrene, 3-(2-ethylhexyl)styrene, 4-(2-ethylhexyl)styrene, allyl styrene, isopropenyl styrene, butenyl styrene, octenyl styrene, 4-t-butoxycarbonyl styrene, and 4-t-butoxystyrene.

Examples of the monofunctional vinyl ether include methyl vinyl ether, ethyl vinyl ether, propyl vinyl ether, n-butyl vinyl ether, t-butyl vinyl ether, 2-ethylhexyl vinyl ether, n-nonyl vinyl ether, lauryl vinyl ether, cyclohexyl vinyl ether, cyclohexyl methyl vinyl ether, 4-methylcyclohexyl methyl vinyl ether, benzyl vinyl ether, dicyclopentenyl vinyl ether, 2-dicyclopentenoxyethyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxypolyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethylcyclohexylmethyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether, and phenoxypolyethylene glycol vinyl ether.

Examples of the monofunctional N-vinyl compound include N-vinylcaprolactam and N-vinylpyrrolidone.

The molecular weight of the monofunctional polymerizable monomer is preferably 500 or less, more preferably 300 or less, and even more preferably 210 or less.

Examples of the lower limit of the molecular weight of the monofunctional polymerizable compound include 50, 60, 70, and the like.

The monofunctional polymerizable monomer preferably includes at least one of a monofunctional (meth)acrylate or a monofunctional N-vinyl compound.

### Photopolymerization Initiator

The ink A contains at least one photopolymerization initiator.

As the photopolymerization initiator, a radical polymerization initiator is preferable.

The radical polymerization initiator has a function of generating radicals by irradiation with light and initiating a polymerization reaction of the aforementioned polymerizable compound.

Examples of the radical polymerization initiator include (a) carbonyl compound such as aromatic ketones, (b) acylphosphine oxide compound, (c) aromatic onium salt compound, (d) organic peroxide, (e) thio compound, (f) hexaarylbiimidazole compound, (g) ketoxime ester compound, (h) borate compound, (i) azinium compound, (j) metallocene compound, (k) active ester compound, (1) carbon halogen bond-containing compound, and (m) alkylamine compound.

As the radical polymerization initiator, one of the above compounds (a) to (m) may be used alone, or two or more compounds among the above compounds (a) to (m) may be used in combination.

As the radical polymerization initiator, the aforementioned (a), (b), or (e) is more preferable.

Preferred examples of (a) carbonyl compound, (b) acylphosphine oxide compound, and (e) thio compound include the compounds having a benzophenone skeleton or a thioxanthone skeleton described in “RADIATION CURING IN POLYMER SCIENCE AND TECHNOLOGY”, J. P. FOUASSIER, J. F. RABEK (1993), pp. 77 ~ 117.

More preferred examples thereof include the α-thiobenzophenone compound described in JP1972-6416B (JP-S47-6416B), the benzoin ether compound described in JP1972-3981A (JP-S47-3981A), the α-substituted benzoin compound described in JP1972-22326B (JP-S47-22326B), the benzoin derivative described in JP1972-23664B (JP-S47-23664B), the aloylphosphonic acid ester described in JP1982-30704A (JP-S57-30704A), the dialkoxybenzophenone described in JP1985-26483B (JP-S60-26483B), the benzoin ethers described in JP-1985-26403B (JP-S60-26403B) and JP-1987-81345A (JP-S62-81345A), the α-aminobenzophenones described in JP1989-34242B (JP-H01-34242B), US4,318,791A, and EP0284561A1, the p-di(dimethylaminobenzoyl)benzene described in JP1990-211452A (JP-H02-211452A), the thio-substituted aromatic ketone described in JP1986-194062A (JP-S61-194062A), the acylphosphine sulfide described in JP1990-9597A (JP-H02-9597A), the acylphosphine described in JP1990-9596A (JP-H02-9596A), the thioxanthones described in JP1988-61950B (JP-S63-61950B), and the coumarins described in JP1984-42864B (JP-S59-42864B).

In addition, the polymerization initiators described in JP2008-105379A and JP2009-114290A are also preferable.

Among the radical polymerization initiators, (a) carbonyl compound or (b) acylphosphine oxide compound is more preferable. Specifically, examples thereof include bis(2,4,6-trimethylbenzoyl)phenylphosphine oxide (for example, OMNIRAD (registered trademark) 819 manufactured by IGM Resins B. V.), 2-(dimethylamine)-1-(4-morpholinophenyl)-2-benzyl-1-butanone (for example, OMNIRAD (registered trademark) 369 manufactured by IGM Resins B. V.), 2-methyl-1-(4-methylthiophenyl)-2-morpholinopropan-1-one (for example, OMNIRAD (registered trademark) 907 manufactured by IGM Resins B. V.), 1-hydroxy-cyclohexyl-phenyl-ketone (for example, OMNIRAD (registered trademark) 184 manufactured by IGM Resins B. V.), 2,4,6-trimethylbenzoyl-diphenyl-phosphine oxide (OMNIRAD (registered trademark) TPO H manufactured by IGM Resins B. V.), and the like.

Among these, from the viewpoint of sensitivity improvement and compatibility with LED light, as the photopolymerization initiator, (b) an acylphosphine oxide compound is preferable, and a monoacylphosphine oxide compound (particularly preferably 2,4,6-trimethylbenzoyl-diphenyl-phosphine oxide) or a bisacylphosphine oxide compound (particularly preferably bis(2,4,6-trimethylbenzoyl)-phenylphosphine oxide) is more preferable.

The content of the photopolymerization initiator in the ink A with respect to the total amount of the ink A is preferably 1.0% by mass to 25.0% by mass, more preferably 2.0% by mass to 20.0% by mass, and even more preferably 3.0% by mass to 15.0% by mass.

### Colorant Sensitizer

It is preferable that the ink A contain at least one colorant sensitizer.

In a case where the ink A contains a colorant sensitizer, photocuring properties can be improved, and particularly the photocuring properties in a case where an LED light source is used can be improved. The colorant sensitizer also contributes to the improvement of light fastness.

The colorant sensitizer is a substance that is electronically excited by absorbing specific active energy rays. The electronically excited colorant sensitizer comes into contact with the radical polymerization initiator and causes actions such as electron migration, energy transfer, and heat generation. As a result, the chemical change, that is, the decomposition of the radical polymerization initiator and the generation of radicals, an acid, or a base are promoted.

Examples of the colorant sensitizer include ethyl 4-(dimethylamino)benzoate (EDB), anthraquinone, a 3-acylcoumarin derivative, terphenyl, styryl ketone, 3-(aroylmethylene)thiazoline, camphorquinone, eosin, rhodamine, erythrosine, a compound represented by General Formula (i) described in JP2010-24276A, and a compound represented by General Formula (I) described in JP1994-107718A (JP-H06-107718A).

In a case where an ink is used in the field of food packaging, it is necessary to ensure food safety and sufficient curing properties. Therefore, from the viewpoint of food safety and from the viewpoint of ensuring better curing properties in consideration of the compatibility with LED light and the reactivity with the photopolymerization initiator, it is preferable that the ink A contain at least one of a thioxanthone-based compound or a thiochromanone-based compound among the colorant sensitizers.

For the thioxanthone compound and the thiochromanone compound, paragraphs “0066” to “0077” of JP2012-46724A may be referred to.

### Thioxanthone Compound

As the thioxanthone compound, a compound represented by Formula (3) is preferable.

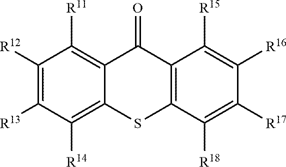

In Formula (3), R¹¹ to R¹⁸ each independently represent a hydrogen atom, an alkyl group, a halogen atom, a hydroxy group, a cyano group, a nitro group, an amino group, an alkylthio group, an alkylamino group (including monosubstituted and disubstituted alkylamino groups), an alkoxy group, an alkoxycarbonyl group, an acyloxy group, an acyl group, a carboxy group, or a sulfo group.

In each of the alkyl group, the alkylthio group, the alkylamino group, the alkoxy group, the alkoxycarbonyl group, the acyloxy group, and the acyl group, the number of carbon atoms in the alkyl moiety is preferably 1 to 20, more preferably 1 to 8, and even more preferably 1 to 4.

The acyloxy group may be an aryloxycarbonyl group, and the acyl group may be an arylcarbonyl group. In this case, in each of the aryloxycarbonyl group and the arylcarbonyl group, the number of carbon atoms in the aryl moiety is preferably 6 to 14, and more preferably 6 to 10.

Among R¹¹ to R¹⁸, two adjacent groups may be linked to each other to form a ring.

Examples of the ring structure include a 5- or 6-membered monocyclic structure; and a binuclear ring (for example, a fused ring) which is a combination of two 5- or 6-membered monocyclic structures.

Examples of the 5- or 6-membered monocyclic structure include an aliphatic ring, an aromatic ring, and a hetero ring. Examples of heteroatoms in the hetero ring include N, O, and S. Examples of the combination of monocyclic rings in the binuclear ring include a combination of aliphatic rings, a combination of an aliphatic ring and an aromatic ring, a combination of an aliphatic ring and a hetero ring, a combination of aromatic rings, a combination of an aromatic ring and a hetero ring, and a combination of hetero rings.

The ring structure may have a substituent. Examples of the substituent include an alkyl group, an alkyl halide group, a halogen atom, a hydroxy group, a cyano group, a nitro group, an amino group, an alkylthio group, an alkylamino group, an alkoxy group, an alkoxycarbonyl group, an acyloxy group, an acyl group, a carboxy group, and a sulfo group.

The halogen atom is preferably a fluorine atom, a chlorine atom, a bromine atom, or an iodine atom, more preferably a chlorine atom, a bromine atom, or an iodine atom, and even more preferably a chlorine atom or a bromine atom.

The alkyl halide group is preferably an alkyl fluoride group.

Examples of the thioxanthone compound include thioxanthone, 2-isopropylthioxanthone, 4-isopropylthioxanthone, 2-chlorothioxanthone, 2,4-dichlorothioxanthone, 2-dodecylthioxanthone, 2,4-diethylthioxanthone, 2,4-dimethylthioxanthone, 1-methoxycarbonylthioxanthone, 2-ethoxycarbonylthioxanthone, 3-(2-methoxyethoxycarbonyl)thioxanthone, 4-butoxycarbonylthioxanthone, 3-butoxycarbonyl-7-methylthioxanthone, 1-cyano-3-chlorothioxanthone, 1-ethoxycarbonyl-3-chlorothioxanthone, 1-ethoxycarbonyl-3-ethoxythioxanthone, 1-ethoxycarbonyl-3-aminothioxanthone, 1-ethoxycarbonyl-3-phenylsulfurylthioxanthone, 3,4-di[2-(2-methoxyethoxy)ethoxycarbonyl]thioxanthone, 1-ethoxycarbonyl-3-(1-methyl-1-morpholinoethyl)thioxanthone, 2-methyl-6-dimethoxymethylthioxanthone, 2-methyl-6-(1,1-dimethoxybenzyl)thioxanthone, 2-morpholinomethylthioxanthone, 2-methyl-6-morpholinomethylthioxanthone, n-allylthioxanthone-3,4-dicarboximide, n-octylthioxanthone-3,4-dicarboximide, N-(1,1,3,3-tetramethylbutyl)thioxanthone-3,4-dicarboximide, 1-phenoxythioxanthone, 6-ethoxycarbonyl-2-methoxythioxanthone, 6-ethoxycarbonyl-2-methylthioxanthone, thioxanthone-2-polyethylene glycol ester, and 2-hydroxy-3-(3,4-dimethyl-9-oxo-9H-thioxanthon-2-yloxy)-N,N,N-trimethyl-1-propanaminiu m chloride.

Among these, from the viewpoint of ease of availability and curing properties, 2,4-diethylthioxanthone, 2-isopropylthioxanthone, or 4-isopropylthioxanthone is preferable.

As the thioxanthone compound, commercially available products on the market may be used.

Examples of the commercial products include a SPEEDCURE series (examples: SPEEDCURE 7010, SPEEDCURE CPTX, SPEEDCURE ITX, and the like) manufactured by Lambson Ltd.

### Thiochromanone Compound

As the thiochromanone compound, a compound represented by Formula (4) is preferable.

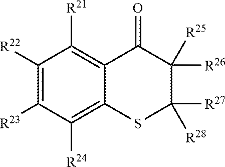

In Formula (4), R²¹ to R²⁸ have the same definitions as R¹¹ to R¹⁸ in Formula (3), and preferred aspects thereof are also the same.

Among R²¹ to R²⁴ in Formula (4), two adjacent groups may be linked to each other to form a ring.

Examples of the ring structure that can be formed of two adjacent groups among R²¹ to R²⁴ in Formula (4) are the same as the examples of the ring structure that can be formed of two adjacent groups among R¹¹ to R¹⁸ in Formula (3).

The thiochromanone compound may have at least one substituent (for example, an alkyl group, an alkyl halide group, a halogen atom, a hydroxy group, a cyano group, a nitro group, an amino group, an alkylthio group, an alkylamino group, an alkoxy group, an alkoxycarbonyl group, an acyloxy group, an acyl group, a carboxy group, or a sulfo group) on the ring structure of thiochromanone.

As the substituent, an alkyl group, a halogen atom, a hydroxy group, an alkylthio group, an alkylamino group, an alkoxy group, or an acyloxy group is preferable, an alkyl group having 1 to 20 carbon atoms or a halogen atom is more preferable, and an alkyl group having 1 to 4 carbon atoms or a halogen atom of is even more preferable.

The halogen atom is preferably a fluorine atom, a chlorine atom, a bromine atom, or an iodine atom, more preferably a chlorine atom, a bromine atom, or an iodine atom, and even more preferably a chlorine atom or a bromine atom.

The alkyl halide group is preferably an alkyl fluoride group.

The thiochromanone compound is more preferably a compound having at least one substituent on each of the aromatic ring and the cyclohexanone ring.

Specific examples of the thiochromanone compound include the following (4-1) to (4-30). Among these, (4-14), (4-17) or (4-19) is more preferable, and (4-14) is even more preferable.

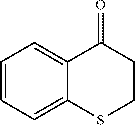 [SMILES: O=C1CCSc2ccccc21]

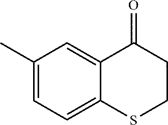

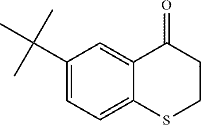

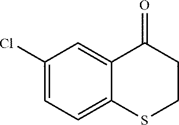 [SMILES: O=C1CCSc2ccc(Cl)cc21]

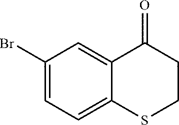 [SMILES: O=C1CCSc2ccc(Br)cc21]

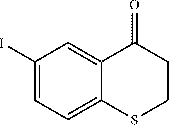 [SMILES: O=C1CCSc2ccc(I)cc21]

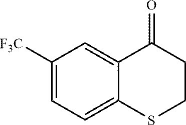 [SMILES: O=C1CCSc2ccc(C(F)(F)F)cc21]

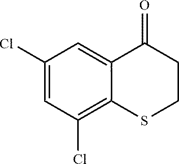 [SMILES: O=C1CCSc2c(Cl)cc(Cl)cc21]

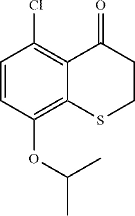 [SMILES: CC(C)Oc1ccc(Cl)c2c1SCCC2=O]

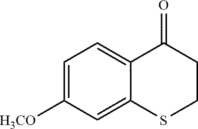 [SMILES: COc1ccc2c(c1)SCCC2=O]

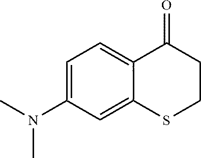

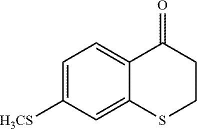

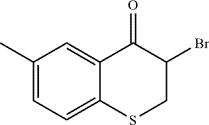

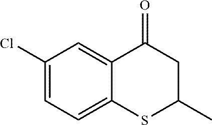

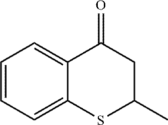

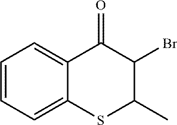

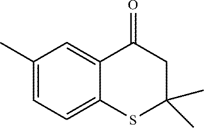

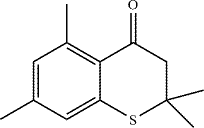

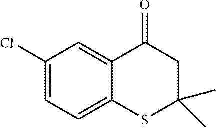

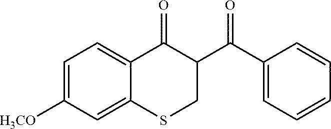 [SMILES: COc1ccc2c(c1)SCC(C(=O)c1ccccc1)C2=O]

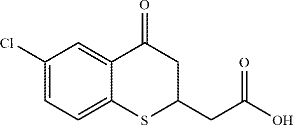 [SMILES: O=C(O)CC1CC(=O)c2cc(Cl)ccc2S1]

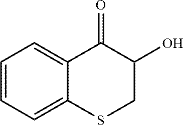 [SMILES: O=C1c2ccccc2SCC1O]

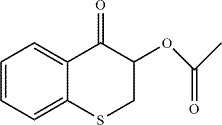

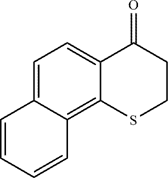 [SMILES: O=C1CCSc2c1ccc1ccccc21]

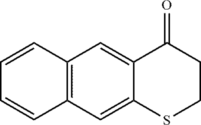 [SMILES: O=C1CCSc2cc3ccccc3cc21]

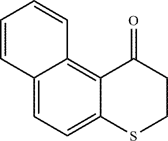 [SMILES: O=C1CCSc2ccc3ccccc3c21]

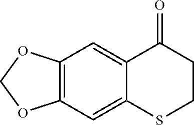 [SMILES: O=C1CCSc2cc3c(cc21)OCO3]

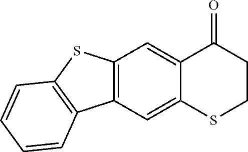 [SMILES: O=C1CCSc2cc3c(cc21)sc1ccccc13]

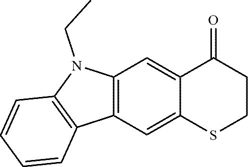 [SMILES: CCn1c2ccccc2c2cc3c(cc21)C(=O)CCS3]

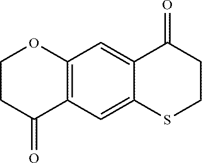 [SMILES: O=C1CCOc2cc3c(cc21)SCCC3=O]

It is preferable that at least one of the colorant sensitizers have a molecular weight of 1,000 or more.

In a case where at least one of the colorant sensitizers has a molecular weight of 1,000 or more, it is possible to suppress a phenomenon (so-called migration) where monomer components are transferred to the outside from the recorded image. It is preferable that at least one of the colorant sensitizers have a molecular weight of 1,000 or more, particularly from the viewpoint of using the ink in the field of food packaging and cosmetic packaging, such as packaging films for foods or packaging materials for cosmetics, where the safety of the substrate is strictly required.

Especially, it is preferable that the ink contain a thioxanthone-based compound having a molecular weight of 1,000 or more or a thiochromanone-based compound having a molecular weight of 1,000 or more.

The molecular weight of the colorant sensitizer is more preferably in a range of 1,000 to 100,000, and more preferably in a range of 1,000 to 50,000.

The content of the colorant sensitizer in the ink A with respect to the total amount of the ink A is preferably 1.0% by mass to 15.0% by mass, more preferably 1.5% by mass to 10.0% by mass, and even more preferably 2.0% by mass to 6.0% by mass.

### Perylene Black

The ink A contains at least one kind of perylene black.

As described above, perylene black is a black pigment that has low absorption in the infrared region, compared to carbon black which is a general black pigment.

Examples of the perylene black include C. I. Pigment Black 31 and C. I. Pigment Black 32.

Here, “C. I.” is an abbreviation for color index.

For perylene black, JP2018-517001A and JP2007-522297A may be referred to.

The content of the perylene black with respect to the total amount of the ink A is preferably 1% by mass to 25% by mass, more preferably 1% by mass to 20% by mass, and even more preferably 2% by mass to 15% by mass.

(Cyan pigment, magenta pigment, and yellow pigment)

The ink A may further contain at least one pigment selected from the group consisting of a cyan pigment, a magenta pigment, and a yellow pigment.

In a case where the ink A contains such a pigment, the tint of the black image recorded with the ink A can be adjusted.

As the cyan pigment, the magenta pigment, and the yellow pigment, known pigments can be used without particular limitation.

In a case where the ink A contains at least one pigment selected from the group consisting of a cyan pigment, a magenta pigment, and a yellow pigment, the total content of the cyan pigment, the magenta pigment, and the yellow pigment with respect to the total amount of the perylene black is preferably 1% by mass to 50% by mass, more preferably 2% by mass to 30% by mass, and even more preferably 3% by mass to 20% by mass.

### Dispersant

The ink A may contain at least one dispersant.

As the dispersant, a polymer dispersant is preferable.

“Polymer dispersant” means a dispersant having a weight-average molecular weight (Mw) of 1,000 or more.

Examples of the polymer dispersant include;
DISPERBYK-101, DISPERBYK-102, DISPERBYK-103, DISPERBYK-106, DISPERBYK-111, DISPERBYK-161, DISPERBYK-162, DISPERBYK-163, DISPERBYK-164, DISPERBYK-166, DISPERBYK-167, DISPERBYK-168, DISPERBYK-170, DISPERBYK-171, DISPERBYK-174, and DISPERBYK-182 (manufactured by BYK-Chemie GmbH);
EFKA4010, EFKA4046, EFKA4080, EFKA5010, EFKA5207, EFKA5244, EFKA6745, EFKA6750, EFKA7414, EFKA745, EFKA7462, EFKA7500, EFKA7570, EFKA7575, EFKA7580, and EFKA7701 (manufactured by EFKA Additives B. V.);
DISPERSE AID 6, DISPERSE AID 8, DISPERSE AID 15, and DISPERSE AID 9100 (manufactured by SAN NOPCO LIMITED);
SOLSPERSE 3000, 5000, 5000S, 9000, 12000, 13240, 13940, 17000, 22000, 24000, 26000, 28000, 32000, 35000, 36000, 39000, 41000, and 71000 (manufactured by The Lubrizol Corporation);
ADEKA PLURONIC L31, F38, L42, L44, L61, L64, F68, L72, P95, F77, P84, F87, P94, L101, P103, F108, L121, and P-123 (manufactured by ADEKA CORPORATION);
IONET S-20 (manufactured by SANYO CHEMICAL INDUSTRIES, LTD.);
DISPARLON KS-860, 873SN, and 874 (polymer dispersants), #2150 (aliphatic polyvalent carboxylic acid), and #7004 (polyether ester type) (manufactured by Kusumoto Chemicals, Ltd.);
and the like.

In a case where the ink A contains a dispersant, the content of the dispersant with respect to the total amount of the ink is preferably 0.05% by mass to 10% by mass, and more preferably 0.1% by mass to 5% by mass.

### Surfactant

The ink A may contain at least one surfactant.

Examples of the surfactant include the surfactants described in JP1987-173463A (JP-S62-173463A) and JP1987-183457A (JP-S62-183457A). Examples of the surfactant include anionic surfactants such as dialkyl sulfosuccinate, alkyl naphthalene sulfonate, and fatty acid salts, nonionic surfactants such as polyoxyethylene alkyl ether, polyoxyethylene alkyl allyl ether, acetylene glycol, and a polyoxyethylene-polyoxypropylene block copolymer, and cationic surfactants such as an alkylamine salt and a quaternary ammonium salt. The surfactant may also be a fluorine-based surfactant or a silicone-based surfactant.

As the surfactant, a silicone-based surfactant (excluding the aforementioned silicone compound having an ethylenically unsaturated group) is preferable.

Examples of the silicone-based surfactant include a polysiloxane compound which is preferably a modified polysiloxane compound obtained by introducing an organic group into some of methyl groups of dimethylpolysiloxane. Examples of the modification include polyether modification, methylstyrene modification, alcohol modification, alkyl modification, aralkyl modification, fatty acid ester modification, epoxy modification, amine modification, amino modification, and mercapto modification. A plurality of types of organic groups may be introduced into some of the methyl groups of the dimethylpolysiloxane.

Among the above, from the viewpoint of jetting stability, a polyether-modified polysiloxane compound is preferable as the silicone-based surfactant.

Examples of the polyether-modified polysiloxane compound include SILWET L-7604, SILWET L-7607N, SILWET FZ-2104, and SILWET FZ-2161 (manufactured by Momentive Performance Materials Japan LLC.), BYK306, BYK307, BYK331, BYK333, BYK347, and BYK348 (manufactured by BYK-Chemie GmbH), and KF-351A, KF-352A, KF-353, KF-354L, KF-355A, KF-615A, KF-945, KF-640, KF-642, KF-643, KF-6020, X-22-6191, X-22-4515, KF-6011, KF-6012, KF-6015, and KF-6017 (manufactured by Shin-Etsu Chemical Co., Ltd.).

In a case where the ink A contains a surfactant, the content of the surfactant with respect to the total amount of the ink A is preferably 0.001% by mass to 4.0% by mass, more preferably 0.01% by mass to 3.0% by mass, and even more preferably 0.05% by mass to 2.0% by mass.

### Polymerization Inhibitor

The ink A may contain at least one polymerization inhibitor.

Examples of the polymerization inhibitor include p-methoxyphenol, quinones (for example, hydroquinone, benzoquinone, methoxybenzoquinone, and the like), phenothiazine, catechols, alkylphenols (for example, dibutylhydroxytoluene (BHT) and the like), alkylbisphenols, zinc dimethyldithiocarbamate, copper dimethyldithiocarbamate, copper dibutyldithiocarbamate, copper salicylate, thiodipropionic acid esters, mercaptobenzimidazole, phosphites, 2,2,6,6-tetramethylpiperidin-1-oxyl (TEMPO), 2,2,6,6-tetramethyl-4-hydroxypiperidin-1-oxyl (TEMPOL), a tris(N-nitroso-N-phenylhydroxylamine) aluminum salt (also known as cupferron Al), and the like.

Among these, at least one polymerization inhibitor selected from p-methoxyphenol, catechols, quinones, alkylphenols, TEMPO, TEMPOL, and a tris(N-nitroso-N-phenylhydroxylamine) aluminum salt is preferable, and at least one polymerization inhibitor selected from p-methoxyphenol, hydroquinone, benzoquinone, BHT, TEMPO, TEMPOL, and a tris(N-nitroso-N-phenylhydroxylamine) aluminum salt is more preferable.

In a case where the ink A contains a polymerization inhibitor, the content of the polymerization inhibitor with respect to the total amount of the ink A is preferably 0.01% by mass to 2.0% by mass, more preferably 0.02% by mass to 1.0% by mass, and particularly preferably 0.03% by mass to 0.5% by mass.

### Organic Solvent

The ink A may contain at least one organic solvent.

Examples of the organic solvent include ketones such as acetone, methyl ethyl ketone, and diethyl ketone; alcohols such as methanol, ethanol, 2-propanol, 1-propanol, 1-butanol, and tert-butanol;
chlorine-based solvents such as chloroform and methylene chloride; aromatic solvents such as benzene and toluene; ester-based solvents such as ethyl acetate, butyl acetate, isopropyl acetate, ethyl lactate, butyl lactate, and isopropyl lactate;
ether-based solvents such as diethyl ether, tetrahydrofuran, and dioxane; glycol ether-based solvents such as ethylene glycol monomethyl ether, ethylene glycol dimethyl ether, and propylene glycol monomethyl ether; and glycol ether acetate-based solvents such as propylene glycol monomethyl ether acetate.

In a case where the ink A contains an organic solvent, the content of the organic solvent with respect to the total amount of the ink A is preferably 1% by mass or less, more preferably 0.5% by mass or less, and even more preferably 0.1% by mass or less. The ink A may have a composition that does not contain an organic solvent (that is, the content of the organic solvent may be 0% by mass with respect to the total amount of the ink A).

### Resin

The ink A may contain at least one resin.

Examples of the resin include an epoxy resin, a vinyl chloride-based resin, a vinyl acetate-based resin, a polyester, a (meth)acrylic resin (for example, a copolymer of methyl methacrylate and n-butyl methacrylate), a chlorinated polyolefin, and a polyketone.

The weight-average molecular weight (Mw) of the resin is preferably 3,000 to 200,000, more preferably 5,000 to 200,000, and even more preferably 10,000 to 150,000.

In a case where the ink A contains a resin, the content of the resin is preferably 1% by mass to 10% by mass with respect to the total amount of the ink A.

### Water

The ink A may contain a small amount of water.

Specifically, the content of water with respect to the total amount of the ink A is preferably 3% by mass or less, more preferably 2% by mass or less, and particularly preferably 1% by mass or less. The ink A is preferably a non-aqueous ink that substantially does not contain water.

### Other Components

The ink A may contain other components in addition to the above components.

Examples of those other components include an ultraviolet absorber, a co-sensitizer, an antioxidant, an antifading agent, a conductive salt, and the like. For those other components, known publications such as JP2011-225848A and JP2009-209352A can be appropriately referred to.

### Physical Properties of Ink A

The viscosity of the ink A is not particularly limited.

The viscosity of the ink A at 25° C. is preferably 10 mPa· s to 50 mPa· s, more preferably 10 mPa· s to 30 mPa· s, and even more preferably 10 mPa· s to 25 mPa· s. The viscosity of the ink can be adjusted, for example, by adjusting the compositional ratio of components contained in the ink.

The viscosity is a value measured using a viscometer: VISCOMETER RE-85L (manufactured by TOKISANGYO).

In a case where the viscosity of the ink A is in the above range, the Jetting stability from an ink jet head can be further improved.

The surface tension of the ink A is not particularly limited.

The surface tension of the ink A at 30° C. is preferably 20 mN/m to 30 mN/m, and more preferably 23 mN/m to 28 mN/m. The surface tension is preferably 30 mN/m or less in view of wettability and 20 mN/m or more in view of bleeding suppression and permeability.

The surface tension is a value measured using a surface tensiometer DY-700 (manufactured by Kyowa Interface Science Co., Ltd.).

### Ink B

The ink B is an ink jet ink which contains a polymerizable compound, a photopolymerization initiator, and an infrared absorbing dye and in which a proportion of a polyfunctional polymerizable monomer in the contained polymerizable compound (that is, a polyfunctional ratio) is 60% by mass or more.

Preferred aspects (such as the composition, the components, and the polyfunctional ratio) of the ink B are the same as the preferred aspects (such as the composition and the components) of the aforementioned ink A, except that the ink B contains an infrared absorbing dye instead of perylene black.

### Infrared Absorbing Dye

The ink B contains at least one infrared absorbing dye.

Examples of the infrared absorbing dye include;
organic colorants such as a phthalocyanine compound, a cyanine compound, a squarylium compound, and an oxonol compound;
inorganic colorants such as LaB₆ (lanthanum hexaboride), CWO (cesium tungsten oxide), ITO (indium tin oxide), and ATO (tin antimonate);
and the like.

From the viewpoint of further improving invisibility of the infrared absorbing image to be recorded (that is, the properties of making it more difficult to visually recognize the infrared absorbing image, the same shall be applied hereinafter) and the infrared readability, the infrared absorbing dye contained in the ink B preferably includes a squarylium compound, and more preferably includes a squarylium compound represented by Formula (1).

In this case, the proportion of the squarylium compound (preferably the squarylium compound represented by Formula (1)) in the infrared absorbing dye contained in the ink B is preferably 50% by mass to 100% by mass, more preferably 60% by mass to 100% by mass, and even more preferably 80% by mass to 100% by mass.

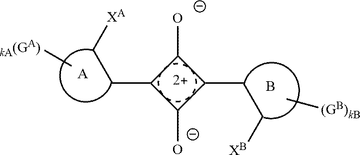

In Formula (1), a ring A and a ring B each independently represent an aromatic ring or a heteroaromatic ring, X^{A} and X^{B} each independently represent a monovalent substituent, G^{A} and G^{B} each independently represent a monovalent substituent, kA represents an integer of 0 to nA, and kB represents an integer of 0 to nB. nA represents an integer which is a maximum number of G^{A}’s capable of substituting the ring A, and nB represents an integer which is a maximum number of G^{B}’s capable of substituting the ring B. X^{A} and G^{A} or X^{B} and G^{B} may be bonded to each other to form a ring, and in a case where there is a plurality of G^{A}’s and a plurality of G^{B}’s, the plurality of G^{A}’s bonded to the ring A may be bonded to each other to form a ring and the plurality of G^{B}’s bonded to the ring B may be bonded to each other to form a ring.

G^{A} and G^{B} each independently represent a monovalent substituent.

Examples of the monovalent substituent include a halogen atom, a cyano group, a nitro group, an alkyl group, an alkenyl group, an alkynyl group, an aryl group, a heteroaryl group, an aralkyl group, —OR¹⁰, —COR¹¹. —COOR¹², —OCOR¹³, —NR¹⁴R¹⁵, —NHCOR¹⁶, —CONR¹⁷R¹⁸, —NHCONR¹⁹R²⁰, —NHCOOR²¹, —SR²², —SO₂R²³, —SO₂OR²⁴, —NHSO₂R²⁵, and SO₂NR²⁶R²⁷.

R¹⁰ to R²⁷ each independently represent a hydrogen atom, an aliphatic group, an aromatic group, or a heterocyclic group.

In a case where R¹² of —COOR¹² is a hydrogen atom (that is, a carboxy group), the hydrogen atom may be dissociated (that is, a carbonate group) or —COOR¹² may be in a state of salt. In a case where R²⁴ of —SO₂OR²⁴ is a hydrogen atom (that is, a sulfo group), the hydrogen atom may be dissociated (that is, a sulfonate group) or —SO₂OR²⁴ may be in a state of salt.

Examples of the halogen atom include a fluorine atom, a chlorine atom, a bromine atom, and an iodine atom.

The number of carbon atoms in the alkyl group is preferably 1 to 20, more preferably 1 to 15, and even more preferably 1 to 8. The alkyl group may be linear, branched, or cyclic, and is preferably linear or branched.

The number of carbon atoms in the alkenyl group is preferably 2 to 20, more preferably 2 to 12, and particularly preferably 2 to 8. The alkenyl group may be linear, branched, or cyclic, and is preferably linear or branched.

The number of carbon atoms in the alkynyl group is preferably 2 to 40, more preferably 2 to 30, and particularly preferably 2 to 25. The alkynyl group may be linear, branched, or cyclic, and is preferably linear or branched.

The number of carbon atoms in the aryl group is preferably 6 to 30, more preferably 6 to 20, and even more preferably 6 to 12.

The alkyl moiety of the aralkyl group is the same as the aforementioned alkyl group. The aryl moiety of the aralkyl group is the same as the aforementioned aryl group. The number of carbon atoms in the aralkyl group is preferably 7 to 40, more preferably 7 to 30, and even more preferably 7 to 25.

The heteroaryl group is preferably a monocyclic ring or a fused ring, more preferably a monocyclic ring or a fused ring composed of 2 to 8 rings fused together, and even more preferably a monocyclic ring or a fused ring composed of 2 to 4 rings fused together. The number of heteroatoms configuring the ring of the heteroaryl group is preferably 1 to 3. The heteroatom configuring the ring of the heteroaryl group is preferably a nitrogen atom, an oxygen atom, or a sulfur atom. The heteroaryl group is preferably a 5-membered ring or a 6-membered ring. The number of carbon atoms configuring the ring of the heteroaryl group is preferably 3 to 30, more preferably 3 to 18, and more preferably 3 to 12. Examples of the heteroaryl group include a pyridine ring, a piperidine ring, a furan ring, a furfuran ring, a thiophene ring, a pyrrole ring, a quinoline ring, a morpholine ring, an indole ring, an imidazole ring, a pyrazole ring, a carbazole ring, a phenothiazine ring, a phenoxazine ring, an indoline ring, a thiazole ring, a pyrazine ring, a thiadiazine ring, a benzoquinoline ring, and a thiadiazole ring.

The alkyl group, the alkenyl group, the alkynyl group, the aralkyl group, the aryl group, and the heteroaryl group may have a substituent or may be unsubstituted.

Examples of the substituent include the substituents described in paragraph “0030” of JP2018-154672A. As the substituent, substituents are preferable which are selected from the group consisting of an alkyl group, an aryl group, an amino group, an alkoxy group, an aryloxy group, an aromatic heterocyclic oxy group, an acyl group, an alkoxycarbonyl group, an aryloxycarbonyl group, an acyloxy group, an acylamino group, an alkoxycarbonylamino group, an aryloxycarbonylamino group, a sulfonylamino group, an alkylthio group, an arylthio group, an aromatic heterocyclic thio group, a sulfonyl group, a hydroxy group, a mercapto group, a halogen atom, a cyano group, a sulfo group, and a carboxy group. Among these, substituents are more preferable which are selected from the group consisting of an alkyl group, an aryl group, an alkoxy group, an aryloxy group, an aromatic heterocyclic oxy group, an acyl group, an alkoxycarbonyl group, an aryloxycarbonyl group, an acyloxy group, an alkylthio group, an arylthio group, an aromatic heterocyclic thio group, a sulfonyl group, a hydroxy group, a mercapto group, a halogen atom, a cyano group, a sulfo group, and a carboxy group.

“Number of carbon atoms” in a substituent means “total number of carbon atoms” in the substituent.

For details of each substituent, the substituents described in paragraphs “0031” to “0035” of JP2018-154672A can be referred to.

X^{A} and X^{B} each independently represent a monovalent substituent.

The substituent represented by X^{A} and X^{B} is preferably a group having active hydrogen, more preferably —OH, —SH, —COOH, —SO₃H, —NR^{X1}R^{X2}, —NHCOR^{X1}, -CONR^{X1}R^{X2}, —NHCONR^{X1}R^{X2}, —NHCOOR^{X1}, —NHSO₂R^{X1}, —B(OH)₂, or PO(OH)₂, and even more preferably —OH, —SH, or NR^{X1}R^{X2}.

R^{X1} and R^{X2} each independently represent a hydrogen atom or a monovalent substituent. Examples of the substituent include an alkyl group, an alkenyl group, an alkynyl group, an aryl group, and a heteroaryl group. Among these, an alkyl group is preferable. The alkyl group is preferably linear or branched. Details of the alkyl group, the alkenyl group, the alkynyl group, the aryl group, and the heteroaryl group are the same as the ranges described above regarding G^{A} and G^{B}.

The ring A and the ring B each independently represent an aromatic ring or a heteroaromatic ring.

The aromatic ring and the heteroaromatic ring may be a monocyclic ring or a fused ring.

Specific examples of the aromatic ring and the heteroaromatic ring include a benzene ring, a naphthalene ring, a pentalene ring, an indene ring, an azulene ring, a heptalene ring, an indecene ring, a perylene ring, a pentacene ring, an acenaphthalene ring, a phenanthrene ring, an anthracene ring, a naphthacene ring, a chrysene ring, a triphenylene ring, a fluorene ring, a biphenyl ring, a pyrrole ring, a furan ring, a thiophene ring, an imidazole ring, an oxazole ring, a thiazole ring, a pyridine ring, a pyrazine ring, a pyrimidine ring, a pyridazine ring, an indolidine ring, an indole ring, a benzofuran ring, a benzothiophene ring, an isobenzofuran ring, a quinolizine ring, a quinoline ring, a phthalazine ring, a naphthyridine ring, a quinoxaline ring, a quinoxazoline ring, an isoquinoline ring, a carbazole ring, a phenanthridine ring, an acridine ring, a phenanthroline ring, a thianthrene ring, a chromene ring, a xanthene ring, a phenoxathiin ring, a phenothiazine ring, and a phenazine ring. Among these, a benzene ring or a naphthalene ring is preferable.

The aromatic ring may be unsubstituted or may have a substituent. Examples of the substituent include the substituents described above regarding G^{A} and G^{B}.

X^{A} and G^{A} or X^{B} and G^{B} may be bonded to each other to form a ring. In a case where there is a plurality of G^{A}’s and a plurality of G^{B}’s, G^{A}’s may be bonded to each other to form a ring, and G^{B}’s may be bonded to each other to form a ring.

The ring is preferably a 5-membered ring or a 6-membered ring. The ring may be a monocyclic ring or a heterocyclic ring.

In a case where X^{A} and G^{A}, X^{B} and G^{B}, G^{A}’s, or G^{B}’s are bonded to each other to form a ring, these may be directly bonded to each other to form a ring or bonded to each other via a divalent linking group selected from the group consisting of an alkylene group, —CO—, —O—, —NH—, —BR—, and a combination of these to form a ring. It is preferable that X^{A} and G^{A}, X^{B} and G^{B}, G^{A}’s, or G^{B}’s be bonded to each other via —BR— to form a ring.

R represents a hydrogen atom or a monovalent substituent. Examples of the substituent include the substituents described above regarding G^{A} and G^{B}. As the substituent, an alkyl group or an aryl group is preferable.

kA represents an integer of 0 to nA, kB represents an integer of 0 to nB, nA represents an integer which is the maximum number of substituents capable of substituting the ring A, and nB represents an integer which is the maximum number of substituents capable of substituting the ring B.

kA and kB preferably each independently represent 0 to 4, more preferably each independently represent 0 to 2, and particularly preferably each independently represent 0 or 1. It is preferable that a case where kA and kB simultaneously represent 0 (zero) be ruled out.

Among the squarylium dyes represented by Formula (1), in view of fastness to light, a compound represented by Formula (2) is preferable.

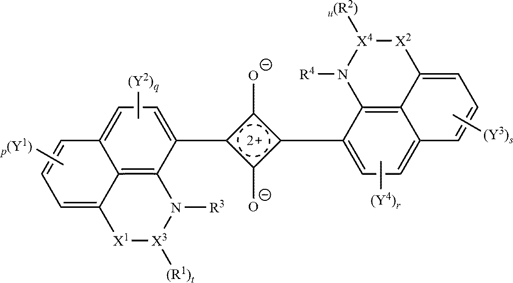

In Formula (2), R¹ and R² each independently represent a monovalent substituent, and R³ and R⁴ each independently represent a hydrogen atom or an alkyl group.

X¹ and X² each independently represent an oxygen atom or —N(R⁵)—, and X³ and X⁴ each independently represent a carbon atom or a boron atom.

t represents 1 in a case where X³ represent a boron atom, and represents 2 in a case where X³ represents a carbon atom. In a case where X³ represents a carbon atom and t is 2, two R¹’s may be bonded to each other to form a ring.

u represents 1 in a case where X⁴ represent a boron atom, and represents 2 in a case where X⁴ represents a carbon atom. In a case where X⁴ represents a carbon atom and u is 2, two R²’s may be bonded to each other to form a ring.

R⁵ represents a hydrogen atom, an alkyl group, an aryl group, or a heteroaryl group, Y¹, Y², Y³, and Y⁴ each independently represent a monovalent substituent. Y¹ and Y², and Y³ and Y⁴ may be bonded to each other to form a ring.

In a case where there is a plurality of Y¹’s, a plurality of Y²’s, a plurality of Y³’s, and a plurality of Y⁴’s, Y¹’s, Y²’s, Y³’s, and Y⁴’s may be bonded to each other to form a ring.

p and s each independently represent an integer of 0 to 3, and q and r each independently represent an integer of 0 to 2.

Examples of the substituents represented by R¹, R², Y¹, Y², Y³, and Y⁴ include the substituents described regarding G^{A} and G^{B}.

R³ and R⁴ each independently represent a hydrogen atom or an alkyl group. The number of carbon atoms in the alkyl group represented by R³ is, for example, 1 to 4 carbon atoms, and preferably 1 or 2. The alkyl group may be linear or branched. Specifically, examples of the alkyl group include a methyl group, an ethyl group, a n-propyl group, an isopropyl group, a n-butyl group, and an isobutyl group. R³ is preferably a hydrogen atom, a methyl group, or an ethyl group, more preferably a hydrogen atom or a methyl group, and particularly preferably a hydrogen atom.

X¹ and X² each independently represent an oxygen atom (—O—) or —N(R⁵)—. X¹ and X² may be the same as or different from each other. It is preferable that X¹ and X² be the same as each other.

R⁵ represents a hydrogen atom, an alkyl group, an aryl group, or a heteroaryl group.

R⁵ is preferably a hydrogen atom, an alkyl group, or an aryl group, and more preferably a hydrogen atom or an alkyl group. The alkyl group, the aryl group, and the heteroaryl group represented by R⁵ may be unsubstituted or may have a monovalent substituent. Examples of the monovalent substituent include the monovalent substituents described above regarding G^{A} and G^{B}.

The number of carbon atoms in the alkyl group is preferably 1 to 20, more preferably 1 to 10, even more preferably 1 to 4, and particularly preferably 1 or 2. The alkyl group may be linear or branched.

The aryl group preferably has 6 to 20 carbon atoms, and more preferably has 6 to 12 carbon atoms.

The heteroaryl group may be monocyclic or polycyclic. The number of heteroatoms configuring the ring of the heteroaryl group is preferably 1 to 3. The heteroatom configuring the ring of the heteroaryl group is preferably a nitrogen atom, an oxygen atom, or a sulfur atom. The number of carbon atoms configuring the ring of the heteroaryl group is preferably 3 to 30, more preferably 3 to 18, and even more preferably 3 to 12.

The molecular weight of the squarylium dye represented by Formula (1) or Formula (2) is preferably in a range of 100 to 2,000, and more preferably in a range of 150 to 1,000.

The squarylium dye represented by Formula (2) is specifically described in JP2011-208101A, and the compounds described in JP2011-208101A can be suitably used as the squarylium dye in the present disclosure.

Specific examples (specific examples S-1 to S-41) of the squarylium dye represented by Formula (1) or Formula (2) will be shown below. However, in the present disclosure, the squarylium dye is not limited to the following compounds. In the formulas, “Me” represents a methyl group, and “Ph” represents a phenyl group.

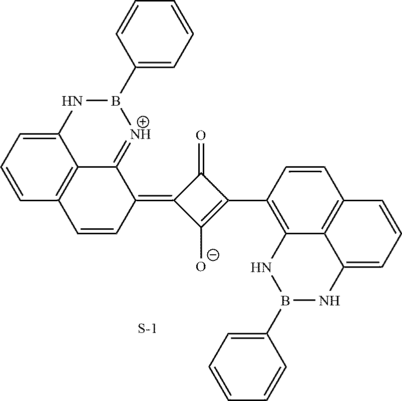

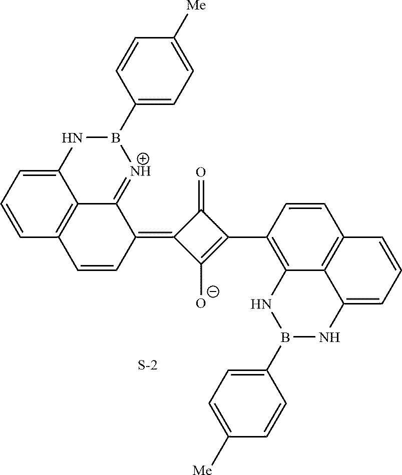

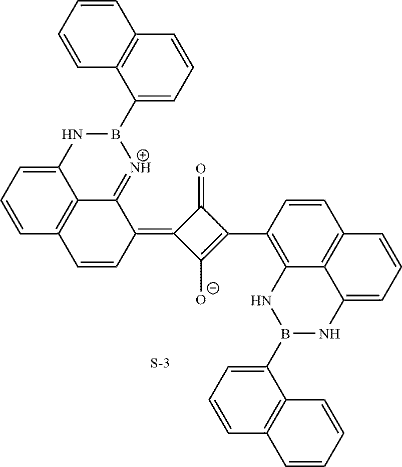

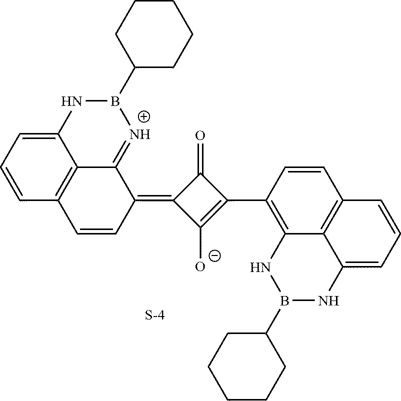

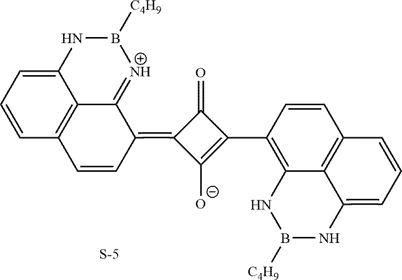

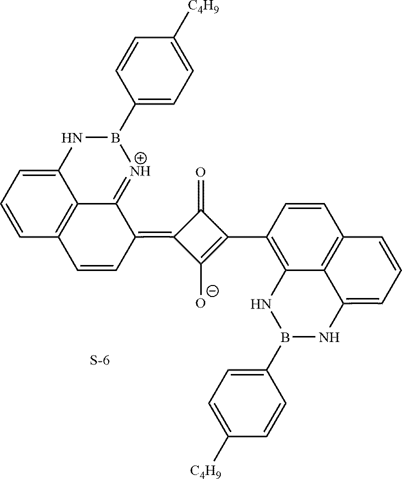

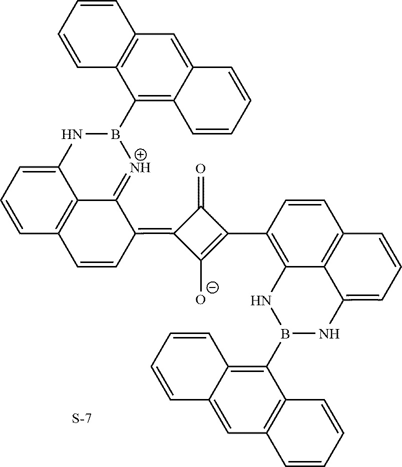

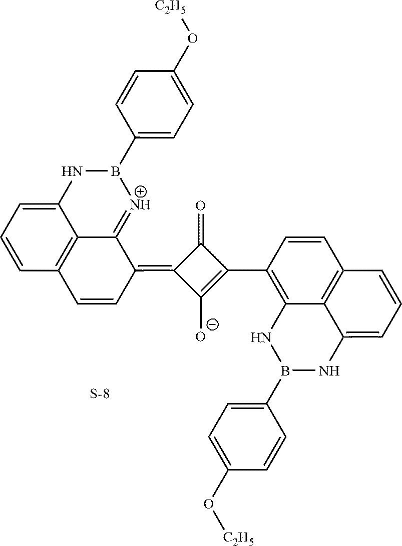

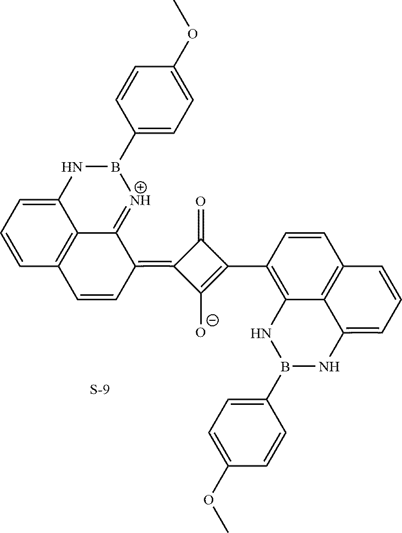

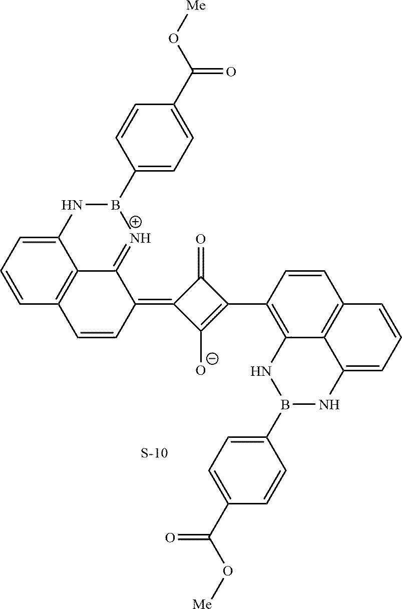

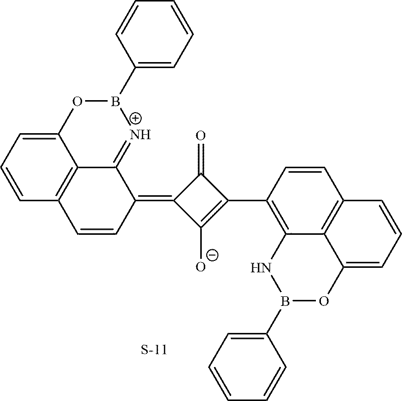

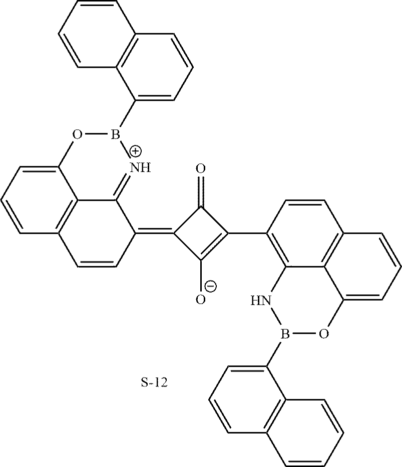

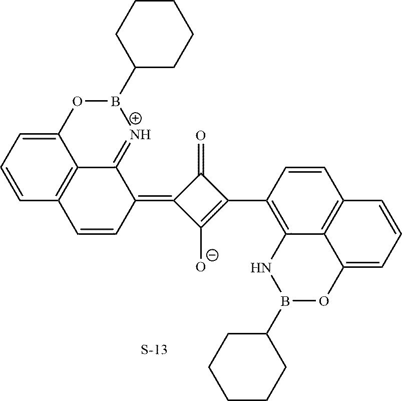

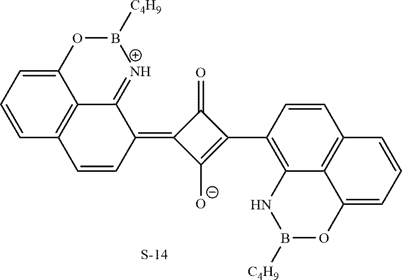

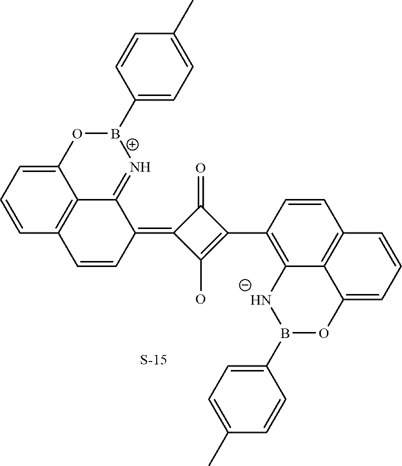

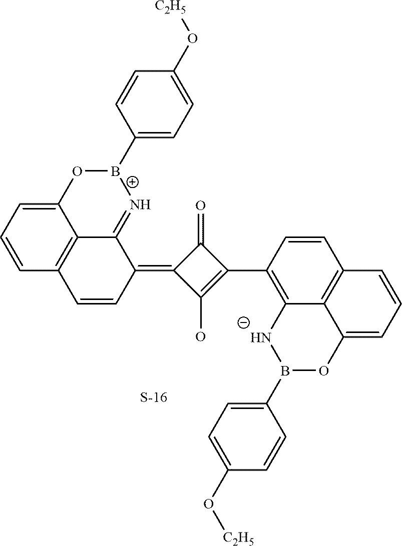

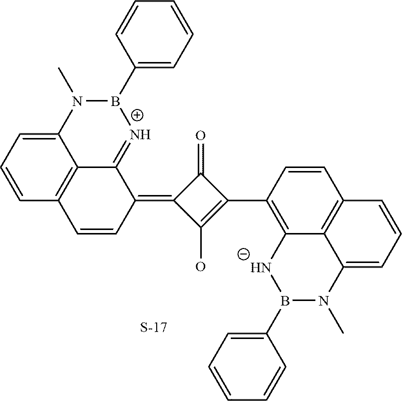

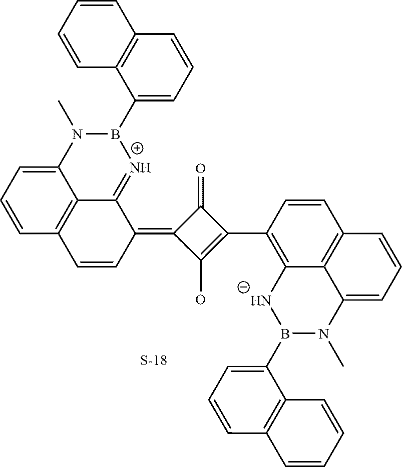

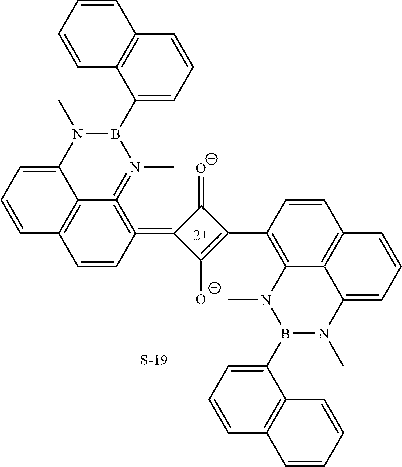

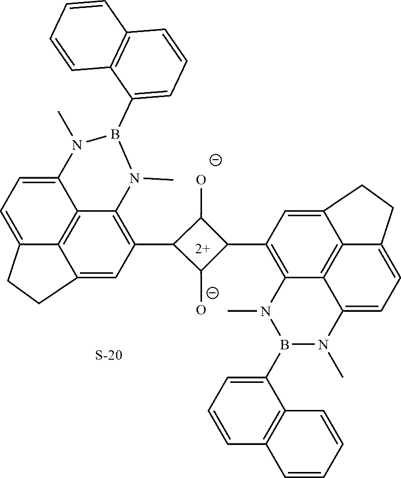

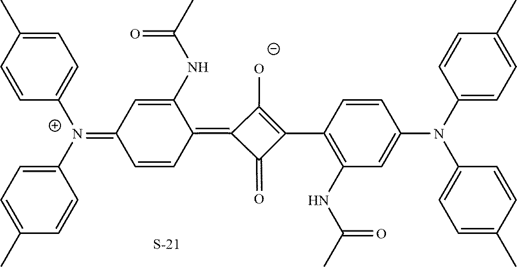

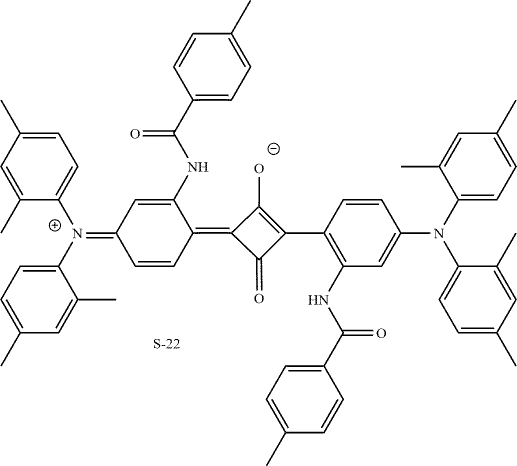

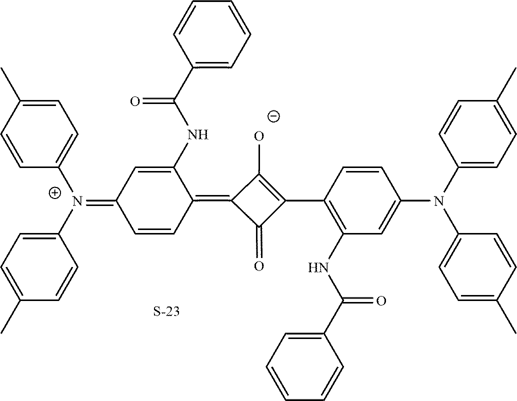

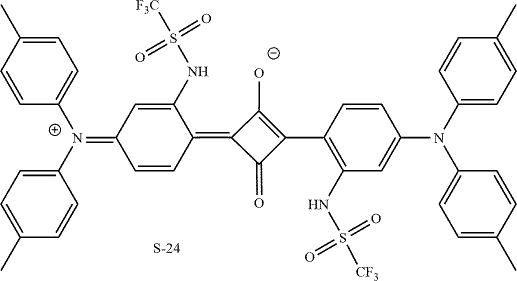

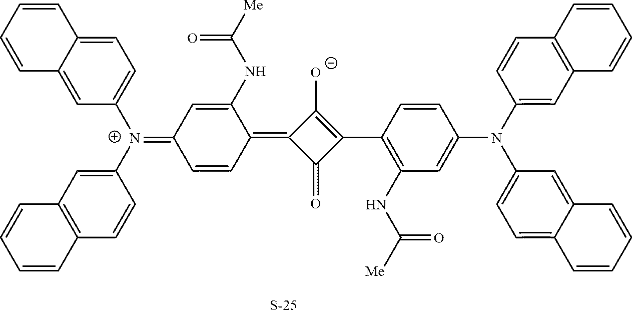

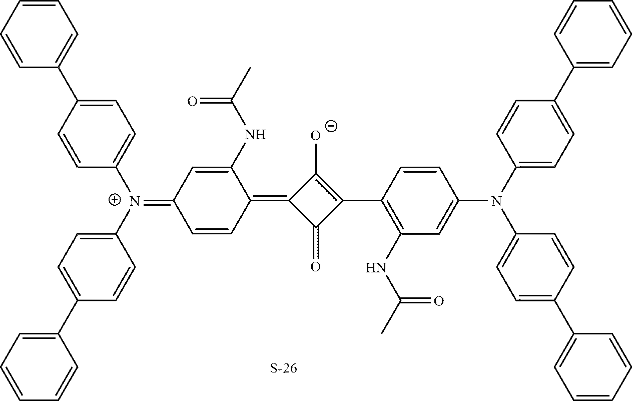

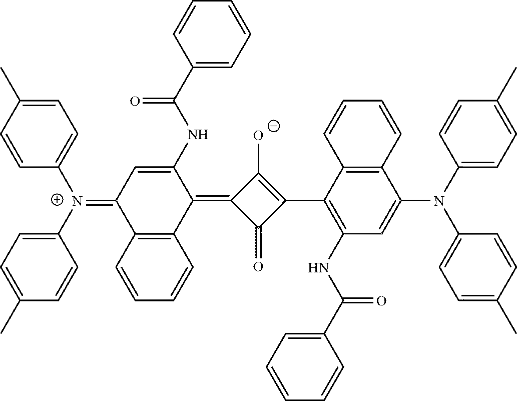 [SMILES: Cc1ccc(N(c2ccc(C)cc2)c2cc(NC(=O)c3ccccc3)c(C3=C([O-])/C(=C4\C(NC(=O)c5ccccc5)=CC(=[N+](c5ccc(C)cc5)c5ccc(C)cc5)c5ccccc54)C3=O)c3ccccc23)cc1]

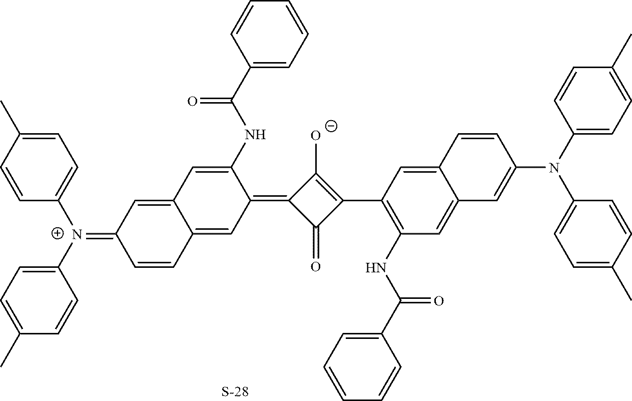

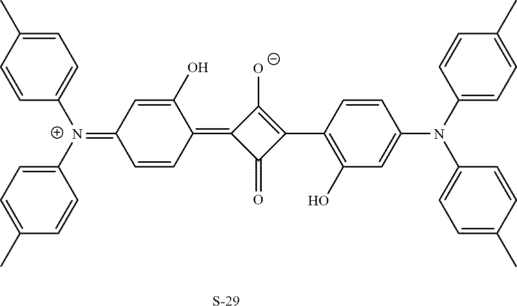

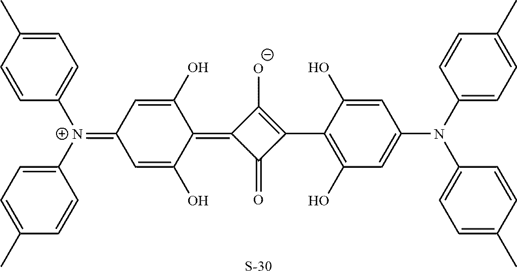

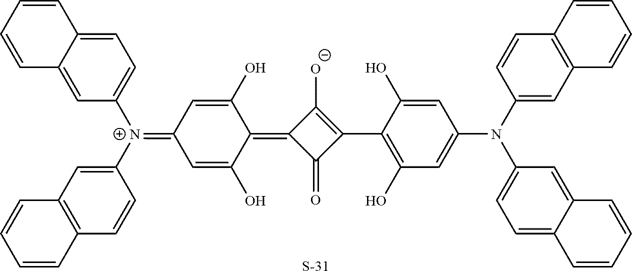

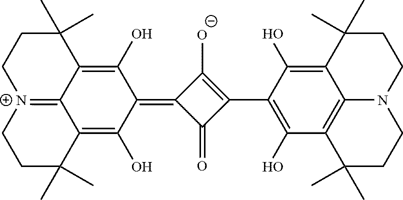

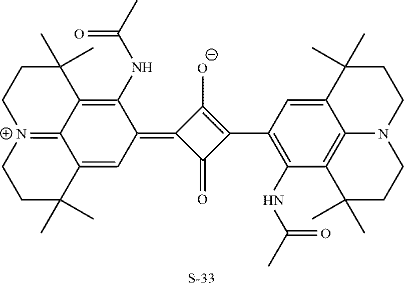

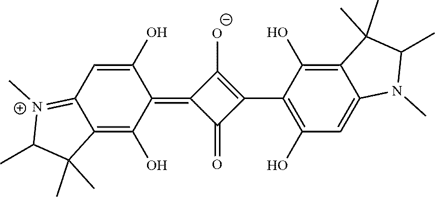

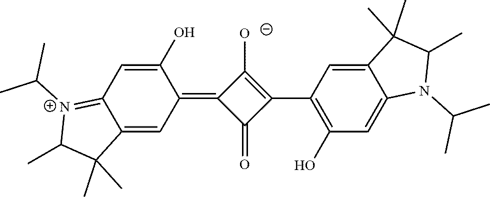 [SMILES: CC(C)N1c2cc(O)c(C3=C([O-])/C(=c4/cc5c(cc4O)=[N+](C(C)C)C(C)C5(C)C)C3=O)cc2C(C)(C)C1C]

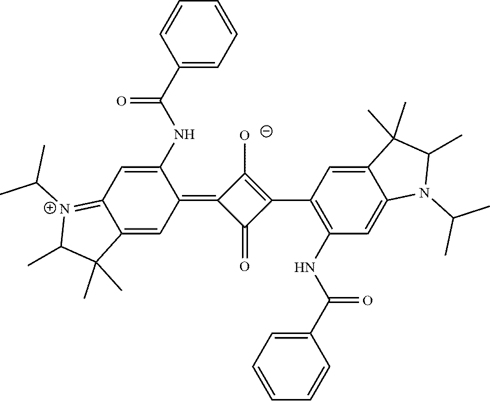 [SMILES: CC(C)N1c2cc(NC(=O)c3ccccc3)c(C3=C([O-])/C(=c4/cc5c(cc4NC(=O)c4ccccc4)=[N+](C(C)C)C(C)C5(C)C)C3=O)cc2C(C)(C)C1C]

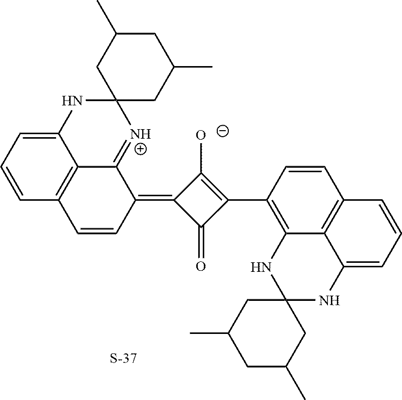

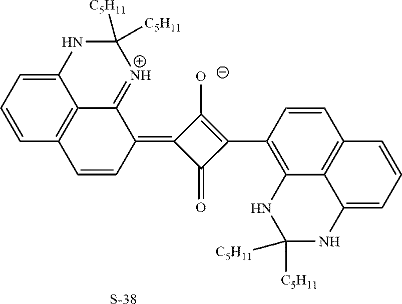

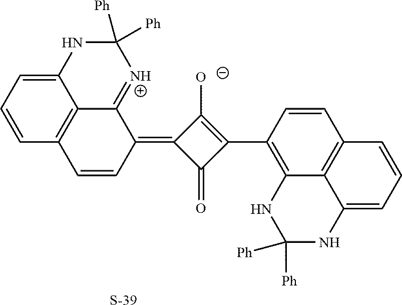

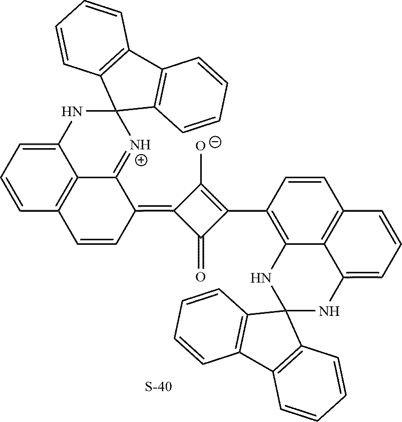

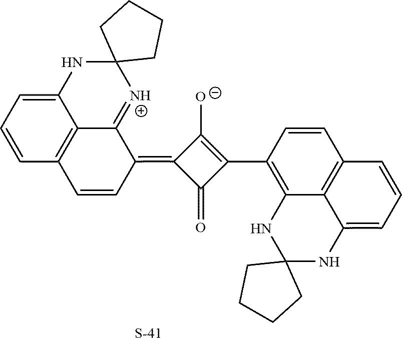

Among the above, examples of more preferred compounds include Specific Examples S-1, S-3, S-4, S-6, S-9, S-11, S-21, S-24, S-30, S-31, S-37, S-38, S-40, and S-41.

The content of the infrared absorbing dye (preferably a squarylium compound, and more preferably a squarylium compound represented by Formula (1)) with respect to the total amount of the ink B is preferably in a range of 0.1% by mass to 20% by mass, more preferably in a range of 0.1% by mass to 10% by mass, and more preferably in a range of 0.3% by mass to 7% by mass.

In a case where the content is 0.1% by mass or more, IR absorptivity and light fastness are further improved.

In addition, in a case where the content is 20% by mass or less, this is advantageous in terms of jetting stability of the ink B.

### Ink C

The ink set of the present disclosure may further comprise an ink jet ink C (also called “ink C” in the present disclosure) which contains a polymerizable compound, a photopolymerization initiator, and a fluorescent substance and in which a proportion of the polyfunctional polymerizable monomer in the contained polymerizable compound (that is, a polyfunctional ratio) is 60% by mass or more.

With the ink set of the aspect comprising the ink C, it is possible to manufacture a printed article comprising a composite image that includes a black image, an infrared absorbing image, and a fluorescence image including an overlap portion where the black image, the infrared absorbing image, and the fluorescence image overlap each other in a plane view.

In the composite image of this aspect, the readability of the black image in the composite image, the readability of the infrared absorbing image in the composite image by infrared rays, and the readability obtained in a case where the fluorescence image in the composite image is irradiated with black light (hereinafter, also called black light readability) are secured.

It is considered that because bleeding of each of the black image, the infrared absorbing image, and the fluorescence image can be suppressed in the recorded composite image, the aforementioned readability may be secured.

Preferred aspects (such as the composition, the components, and the polyfunctional ratio) of the ink C are the same as the preferred aspects (such as the composition, the components, and the polyfunctional ratio) of the aforementioned ink A, except that the ink C contains a fluorescent substance instead of perylene black.

### Fluorescent Substance

As the fluorescent substance, fluorescing substances can be used without particular limitations.

The fluorescent substance may be an inorganic compound, an organic compound, or an organic-inorganic complex.

Examples of the fluorescent substance which is an inorganic compound include red phosphors such as YVO₄:Eu, Y₂O₃:Eu, Y₂SiO₅:Eu, Y₃A1O₁₂:Eu, Y₂O₂S:Eu, Bi, Zn₃(PO₄)₂:Mn, YBO₃:Eu, CaLa₂S₄:Ce, (Y, Gd)BO₃:Eu, SrS:Eu, (Ca,Sr)S:Eu, GdBO₃:Eu, ScBO₃:Eu, LuBO₃:Eu, YVO₄:Bi, Eu, and YVO₄:Pb, Eu.

Examples of the fluorescent substance which is an inorganic compound include blue phosphors such as Y₂SiO₅:Ce, CaWO₄:Pb, BaMgAl₁₄O₂₃:Eu, BaMgAl₁₀O₁₇:Eu, Mn, Zn₂GeO₄:Mn, and MgA1₂O₄:Ce.

Examples of the fluorescent substance which is an inorganic compound include green phosphors such as Zn₂SiO₄: Mn, BaA1₁₂O₁₉:Mn, BaMgA1₁₄O₂₃: Mn, SrA1₁₃O₁₉:Mn, CaA1₁₂O₁₉:Mn, YBO₃:Tb, YBO₃:Ce, Tb, LaPO₄:Ce, Tb, LuBO₃:Tb, GdBO₃:Tb, ScBO₃:Tb, Sr₆Si₃O₃C₁₄:Eu, and YVO₄:Tb.

Examples of the fluorescent substance which is an organic compound include fluorescein, eosin, rhodamine B, rhodamine 6G, thioflavin, diaminostilbene disulfonic acid, imidazole, coumarin, triazole, carbazole, pyridine, naphthalic acid, imidazolone, anthracene, and derivatives of these compounds.

Examples of the fluorescent substance which is an organic-inorganic complex compound include the organic-inorganic complexes described in JP5630752B.

From the viewpoint of further improving the invisibility of the recorded fluorescence image to be recorded and the black light readability, it is preferable to use a fluorescent substance which is an organic compound as the fluorescent substance.

The content of the fluorescent substance with respect to the total amount of the ink C is preferably 1% by mass to 20% by mass, more preferably 1% by mass to 10% by mass, and even more preferably 2% by mass to 8% by mass.

### Ink D

The ink set of the present disclosure may include at least one ink D containing a polymerizable compound, a photopolymerization initiator, and a coloring agent.

The ink D is preferably at least one ink selected from the group consisting of a cyan ink containing a cyan coloring agent (preferably, a cyan pigment) as a coloring agent, a magenta ink containing a magenta coloring agent (preferably a magenta pigment) as a coloring agent, and a yellow ink containing a yellow coloring agent (preferably a yellow pigment) as a coloring agent.

With the ink set of the aspect containing the ink D, it is possible to record a color image (at least one of the cyan image, magenta image, and yellow image) for adjusting tint of the black image derived from the ink A.

In this case, the color image is recorded on at least a portion of the black image (specifically, at a position that overlaps at least a portion of the black image in a plane view).

In the ink D, a proportion of a polyfunctional polymerizable monomer in the contained polymerizable compound (that is, a polyfunctional ratio) is preferably 60% by mass or more.

Preferred aspects (such as the composition, the components, and the polyfunctional ratio) of the ink D are the same as the preferred aspects (such as the composition, the components, and the polyfunctional ratio) of the aforementioned ink A, except that the ink D contains a coloring agent instead of perylene black.

### Printed Article

The printed article of the present disclosure comprises
a substrate, and
a composite image that is disposed on the substrate and includes a black image and an infrared absorbing image including an overlap portion where the black image and the infrared absorbing image overlap each other in a plane view,
in which the black image is a cured substance of an ink A which contains a polymerizable compound, a photopolymerization initiator, and perylene black and in which a proportion of a polyfunctional polymerizable monomer in the contained polymerizable compound is 60% by mass or more, and
the infrared absorbing image is a cured substance of an ink B which contains a polymerizable compound, a photopolymerization initiator, and an infrared absorbing dye and in which a proportion of a polyfunctional polymerizable monomer in the contained polymerizable compound is 60% by mass or more.

The ink A and the ink B in the printed article of the present disclosure have the same definitions as the ink A and the ink B in the ink set of the present disclosure, respectively.

Therefore, the printed article of the present disclosure brings about the same effect as the effect brought about by the ink set of the present disclosure can be obtained.

That is, in the printed article of the present disclosure, the readability of the black image in the composite image and the IR readability of the infrared absorbing image (hereinafter, also called “IR image”) in the composite image are simultaneously achieved.

### Substrate

The printed article of the present disclosure comprises a substrate.

The substrate may be a permeable substrate, such as paper, or an impermeable substrate.

The images (the black image and the infrared absorbing image) in the printed article of the present disclosure are cured substances of ink A and ink B which are active energy ray curable-type inks containing a polymerizable compound and a photopolymerization initiator. Therefore, even in a case where the substrate is an impermeable substrate, it is easy to secure the adhesiveness between the substrate and the image. Accordingly, the article with a recorded image of the present disclosure is particularly suitable as an article with a recorded image comprising an impermeable substrate as a substrate.

In the present disclosure, an impermeable substrate refers to a substrate having a water absorption rate (% by mass, 24 hr.) less than 0.2 in ASTM D570 which is the ASTM test method.

In the present disclosure, a permeable substrate refers to a substrate having a water absorption rate (% by mass, 24 hr.) of 0.2 or more in ASTM D570 which is the ASTM test method.

Examples of the impermeable substrate include a glass substrate, a quartz substrate, a silicon substrate, and a plastic substrate.

As the substrate, a substrate provided with elements such a wiring line, a transistor, a diode, a light-receiving element, a sensor, and an actuator in advance may be used.

Examples of the resin constituting the plastic substrate include cellulose diacetate, cellulose triacetate, cellulose propionate, cellulose butyrate, cellulose acetate butyrate, cellulose nitrate, an acrylic resin, a chlorinated polyolefin resin, a polyether sulfone resin, polyethylene terephthalate (PET), polyethylene naphthalate, nylon, polyethylene, polystyrene (PS), polypropylene (PP), a polycycloolefin resin, a polyimide resin, a polycarbonate (PC) resin, and polyvinyl acetal.

The plastic substrate may be a substrate containing only one of these resins or a substrate containing two or more of these resins.

A gas barrier layer and/or a solvent-resistant layer may be provided on the surface of the plastic substrate.

The thickness of the impermeable substrate is not particularly limited, but is preferably 10 µm to 2,000 µm, more preferably 20 µm to 1,000 µm, even more preferably 30 µm to 500 µm, and particularly preferably 30 µm to 400 µm.

### Composite Image

The printed article of the present disclosure comprises a composite image disposed on the substrate.

The composite image in the printed article of the present disclosure includes a black image and an IR image including an overlap portion where the black image and the IR image overlap each other in a plane view.

The overlap portion may be a part or the entirety of the black image, or may be a part or the entirety of the IR image.

In the overlap portion in the composite image, any of the black image and the IR image may be the top (that is, the side far from the substrate) or bottom (that is, the side close to the substrate). Regardless of which of the black image and the IR image is the top, it is possible to read the black image in the composite image by the irradiation with visible light and to read the IR image in the composite image by the irradiation with infrared rays (IR).

As the black image in the composite image, at least one of a bar code image or a QR code (registered trademark) image is preferable.

As the IR image in the composite image, a dot code image is preferable.

Examples of the dot code image include a screen code provided by Apollo Japan Co., Ltd.

### Color Image

The composite image in the printed article of the present disclosure may further include at least one color image selected from the group consisting of a cyan image that overlaps the black image in a plane view, a magenta image that is superposed on the black image in a plane view, and a yellow image that is superposed on the black image in a plane view.

In a case where the composite image includes a color image, the tint of the black image can be adjusted.

Any of the black image and the color image may be the top (that is, the side far from the substrate). It is preferable that the color image be the top. Furthermore, it is preferable that the color image be an image that is superposed on a part or the entirety of the black image.

From the viewpoint of ease of adjusting the tint of the black image, one of the preferred aspects is an aspect in which a color image having a halftone dot rate less than 100% (more preferably 50% or less, even more preferably 40% or less, and still more preferably 30% or less) is disposed on the black image which is a solid image (halftone dot rate of 100%).

It is possible to record the color image by using inks of the corresponding colors.

The color image is preferably a cured substance of the ink D (at least one ink selected from the group consisting of a cyan ink, a magenta ink, and a yellow ink) described above in the section of ink set.

### Fluorescence Image

The composite image in the printed article of the present disclosure may further include a fluorescence image.

In a case where the composite image includes the fluorescence image, it is possible to read the fluorescence image by irradiating the composite image with black light.

The fluorescence image is preferably a cured substance of the ink C (that is, the ink D described above in the section of ink set) which contains a polymerizable compound, a photopolymerization initiator, and a fluorescent substance and in which a proportion of a polyfunctional polymerizable monomer in the contained polymerizable compound is 60% by mass or more. In a case where the fluorescence image is such a cured substance, bleeding of the fluorescence image in the composite image is suppressed. Accordingly, the readability of the fluorescence image by the irradiation with black light (hereinafter, also called “black light readability”) is improved.

The fluorescence image is preferably an image that overlaps the overlap portion (that is, the overlap portion of the black image and the IR image) in a plane view.

### Other Images

The composite image in the printed article of the present disclosure may include an image (for example, a color image that does not overlap the black image) other than the images described above.

In addition, the printed article of the present disclosure may comprise an image (for example, a color image and/or a black image provided in a region other than the composite image) other than the composite image described above.

### Example of Manufacturing Method of Printed Article (Manufacturing Method X)

The printed article of the present disclosure can be manufactured using the ink set (that is, a combination including the ink A and the ink B) of the present disclosure described above.

One of the examples of the manufacturing method of the printed article (hereinafter, called manufacturing method X) includes
an ink applying step of applying the ink A and the ink B on a substrate in an arrangement in which the aforementioned overlap portion is formed, and
an irradiation step of irradiating the ink A and the ink B applied on the substrate with an active energy ray to obtain a composite image.

The manufacturing method X may include other steps as necessary.

### Ink Applying Step

The ink applying step is a step of applying the ink A and the ink B on a substrate in an arrangement in which the aforementioned overlap portion is formed.

In the ink applying step, inks other than the ink A and the ink B (for example, the ink C and/or the ink D described above) may be applied as necessary.

In the ink applying step, whenever each ink is applied on the substrate, the ink on the substrate may be irradiated with an active energy ray. That is, the application of each ink may be performed while the application of the ink and the irradiation with an active energy ray are being repeated.

In addition, in the ink applying step, at a point in time when a plurality of inks has been applied on a substrate, the plurality of inks on the substrate may be irradiated with an active energy ray, and then the next ink may be applied.

Furthermore, in the ink applying step, inks may be sequentially applied without being irradiated with an active energy ray. In this case, in an irradiation step following the ink applying step, all the inks are cured together.

In any aspect of the ink applying step, in the irradiation step, at least the ink A and the ink B are irradiated with active energy rays, such that the inks are cured and a composite image including at least a black image and an IR image is recorded.

In this step, each ink is applied on a substrate by an ink jet method.

That is, in this step, each ink is jetted from jetting holes (nozzles) of an ink jet head and applied on a substrate.

The ink jet head can be driven, such that multi-size dots preferably having a volume of 1 pL to 100 pL and more preferably having a volume of 8 pL to 30 pL can be jetted preferably at a resolution of 320 dpi (dot per inch) × 320 dpi to 4,000 dpi × 4,000 dpi, more preferably at a resolution of 400 dpi × 400 dpi to 1,600 dpi × 1,600 dpi, and even more preferably at a resolution of 720 dpi × 720 dpi to 1,600 dpi × 1,600 dpi. dpi represents the number of dots per 2.54 cm (1 inch).

A single-pass method or a multi-pass method may be used as the method of applying the ink by the ink jet method. From the viewpoint of image recording speed, a single-pass method is preferable.

The single-pass method is a method of using, as an ink jet head, a line head having jetting holes (nozzles) arranged to correspond to entire area of one side of a substrate, in which the line head is disposed at a fixed position, and while the substrate is being transported in a direction intersecting with the arrangement direction of the jetting holes of the line head, an ink is applied on the substrate being transported.

On the other hand, the multi-pass method (also called a scanning method) is a method of using a short serial head as an ink jet head, in which a substrate is scanned with the short serial head such that an ink is applied to the substrate.

In the single-pass method, by causing the substrate to be scanned in a direction intersecting with the arrangement direction of the jetting holes, a pattern can be formed on the entire surface of the substrate. Therefore, this method does not require a transport system such as a carriage that transports short heads for scanning. Furthermore, in the single-pass method, complicated scanning control for moving a carriage and a substrate is not necessary, and only a substrate moves. Therefore, the recording speed can be further increased in the single-pass method than in the multi-pass method.

### Irradiation Step

The irradiation step is a step of irradiating the ink A and the ink B applied on the substrate with an active energy ray to obtain a composite image.

By this step, a composite image is obtained which includes a black image as a cured substance of the ink A and an IR image as a cured substance of the ink B.

In a case where an ink other than the ink A and the ink B (for example, the ink C and/or the ink D described above) is applied in the ink applying step, the inks other than the ink A and the ink B are also cured in a curing step.

The active energy ray is preferably an ultraviolet (UV) ray and/or visible light.

The peak wavelength of the active energy ray is, for example, preferably 200 nm to 405 nm, more preferably 250 nm to 400 nm, and even more preferably 300 nm to 400 nm.

As the light source for ultraviolet irradiation, a mercury lamp, a gas laser, and a solid-state laser are mainly used. A mercury lamp, a metal halide lamp, and an ultraviolet fluorescent lamp are widely known light sources. Being compact, highly efficient, low cost, and having a long life, UV-LED (light emitting diode) and UV-LD (laser diode) are promising light sources for ultraviolet irradiation. As the light source for ultraviolet irradiation, among these, a metal halide lamp, a high-pressure mercury lamp, a medium-pressure mercury lamp, a low-pressure mercury lamp, or UV-LED is preferable.

From the viewpoint of further improving the adhesiveness between the substrate and the image, the illuminance of the active energy ray is preferably 1.0 W/cm or more, more preferably 2.0 W/cm or more, and even more preferably 4.0 W/cm or more.

The upper limit of the illuminance of the active energy ray is not particularly limited, but is, for example, 10 W/cm.

From the viewpoint of further improving the adhesiveness between the substrate and the image, the irradiation energy (that is, the exposure amount) of the active energy ray is preferably 20 mJ/cm² or more, and more preferably 80 mJ/cm² or more.

The upper limit of the irradiation energy of the active energy ray is not particularly limited, but is, for example, 240 mJ/cm².

The irradiation with the active energy ray is preferably performed in an atmosphere at an oxygen concentration of 0.1% by volume or less. In a case where the irradiation with the active energy ray A is performed in this atmosphere, oxygen is inhibited from hindering polymerization, and an image having higher adhesiveness with the substrate is obtained.

The atmosphere at an oxygen concentration of 0.1% by volume or less is suitably an atmosphere in the presence of an inert gas (for example, a nitrogen gas, an argon gas, or a helium gas).

### Examples

Hereinafter, examples of the present disclosure will be described, but the present disclosure is not limited to the following examples.

Hereinafter, unless otherwise specified, “parts” and “%” are based on mass.

In addition, hereinafter, “solvent” means an organic solvent.

### Preparation of Ink A

Inks A1 to A7 as the inks A containing perylene black were prepared.

The details will be described below.

### Preparation of Ink A1 (Polyfunctional Ratio 100% by Mass)

### Preparation of Dispersion A1

The components having the following composition were mixed together and dispersed with a beads mill for 3 hours, thereby obtaining a dispersion A1 which is a perylene black dispersion.

-Composition of dispersion A1-
Pigment Black 31 (perylene black)··· 20 parts
SOLSPERSE 35000 (manufactured by The Lubrizol Corporation; polymer dispersant)··· 5 parts
SR341 (manufactured by Sartomer Company Inc.: polyfunctional radically polymerizable monomer; 3-methyl-1,5-pentanediol diacrylate)··· 75 parts

### Preparation of Ink A1

The components having the following composition were mixed together and stirred, thereby obtaining an ink A1.

In the ink A1, the proportion of the polyfunctional polymerizable monomer in the polymerizable compound was 100% by mass.

-Composition of ink A1-
Dispersion A1 described above (perylene black dispersion)··· 25 parts
SR341 (manufactured by Sartomer Company Inc.: polyfunctional radically polymerizable monomer; 3-methyl-1,5-pentanediol diacrylate)··· 66.8 parts
OMNIRAD (registered trademark) 819 (manufactured by IGM Resins B. V.; radical polymerization initiator; acylphosphine oxide compound)··· 4 parts
SPEEDCURE (registered trademark) 7010L (manufactured by Lambson Ltd.; colorant sensitizer; thioxanthone-based compound having molecular weight of 1,000 to 2,000)··· 4 parts
FLORSTAB UV12 (manufactured by Kromachem Ltd; nitroso-based polymerization inhibitor; tris(N-nitroso-N-phenylhydroxylamine) aluminum salt)··· 0.1 parts

BYK307 (manufactured by BYK-Chemie Japan K.K.; silicone-based surfactant; polyether-modified polysiloxane compound)··· 0.1 parts

### Preparation of ink A2 (Polyfunctional Ratio 65% by Mass)

An ink A2 was prepared in the same manner as in Preparation of ink A1 except for following points.

In the ink A2, the proportion of the polyfunctional polymerizable monomer in the polymerizable compound is 65% by mass.

### Difference From The Preparation of Ink A1-

A part of SR341 (66.8 parts) in the preparation of the ink A1 was replaced with CTFA (cyclic trimethylolpropane formal acrylate; monofunctional radically polymerizable monomer). The amount of CTFA used was adjusted, such that the proportion of the polyfunctional polymerizable monomer in the polymerizable compound contained in the ink was 65% by mass.

### Preparation of Ink A3 (Comparative Ink) (Polyfunctional Ratio 50% by Mass)

An ink A3 (comparative ink) was prepared in the same manner as in Preparation of ink A1 except for following points.

In the ink A3, the proportion of the polyfunctional polymerizable monomer in the polymerizable compound is 50% by mass.

### Difference From The Preparation of Ink A1

A part of SR341 (66.8 parts) in the preparation of the ink A1 was replaced with CTFA (cyclic trimethylolpropane formal acrylate; monofunctional radically polymerizable monomer). The amount of CTFA used was adjusted, such that the proportion of the polyfunctional polymerizable monomer in the polymerizable compound contained in the ink A3 was 50% by mass.

### Preparation of Ink A4 (Polyfunctional Ratio 65% by Mass: Pigment Black 32)

A dispersion A2 was prepared in the same manner as in Preparation of dispersion A1, except that in Preparation of dispersion A1, Pigment Black 31 as perylene black was replaced with Pigment Black 32 as perylene black.

An ink A4 was prepared in the same manner as in Preparation of ink A2, except that in Preparation of ink A2, the dispersion A2 having the same mass as the dispersion A1 was used instead of the dispersion A1.

In the ink A4, the proportion of the polyfunctional polymerizable monomer in the polymerizable compound is 65% by mass.

### Preparation of Ink A5 (Polyfunctional Ratio 65% by Mass, Containing Cyan Pigment)

### Preparation of Dispersion D1C

The components in the following composition were put in a disperser motor mill M50 (manufactured by Eiger Torrance Limited) and dispersed and mixed together using zirconia beads having a diameter of 0.65 mm at a circumferential speed of 9 m/s for 4 hours, thereby obtaining a dispersion D1C (cyan pigment dispersion).

-Composition of dispersion D1C-
IRGALITE BLUE GLVO (manufactured by BASF Japan Ltd.; cyan pigment)··· 30 parts
SR9003 (manufactured by Sartomer Company Inc.; polyfunctional radically polymerizable monomer; propoxylated (2) neopentyl glycol diacrylate)··· 62 parts
SOLSPERSE 32000 (manufactured by The Lubrizol Corporation; dispersant)··· 8 parts

### Preparation of Ink A5

The components in the following composition were mixed together and stirred, thereby obtaining an ink A5.

In the ink A5, the proportion of the polyfunctional polymerizable monomer in the polymerizable compound is 65% by mass.

-Composition of Ink A5-
Dispersion A1 described above (perylene black dispersion)··· 25 parts
Dispersion D1C described above (cyan pigment dispersion)··· 1.7 parts
SR341 (manufactured by Sartomer Company Inc.: polyfunctional radically polymerizable monomer; 3-methyl-1,5-pentanediol diacrylate)··· 35.16 parts
CTFA (monofunctional radically polymerizable monomer; cyclic trimethylolpropane formal acrylate)··· 29.94 parts
OMNIRAD (registered trademark) 819 (manufactured by IGM Resins B. V.; radical polymerization initiator; acylphosphine oxide compound)··· 4 parts
SPEEDCURE (registered trademark) 7010L (manufactured by Lambson Ltd.; colorant sensitizer; thioxanthone-based compound having molecular weight of 1,000 to 2,000)··· 4 parts
FLORSTAB UV12 (manufactured by Kromachem Ltd; nitroso-based polymerization inhibitor; tris(N-nitroso-N-phenylhydroxylamine) aluminum salt)··· 0.1 parts

BYK307 (manufactured by BYK-Chemie Japan K.K.; silicone-based surfactant; polyether-modified polysiloxane compound)··· 0.1 parts

### Preparation of Ink A6 (Polyfunctional Ratio 65% by Mass, Containing Magenta Pigment)

### Preparation of Dispersion D1M

The components in the following composition were put in a disperser motor mill M50 (manufactured by Eiger Torrance Limited) and dispersed and mixed together using zirconia beads having a diameter of 0.65 mm at a circumferential speed of 9 m/s for 4 hours, thereby obtaining a dispersion D1M (magenta pigment dispersion).

-Composition of dispersion D1M-
CINQUASIA MAGENTA RT-355-D (manufactured by BASF Japan Ltd.; magenta pigment)···30 parts
SR9003 (manufactured by Sartomer Company Inc.; polyfunctional radically polymerizable monomer; propoxylated (2) neopentyl glycol diacrylate)··· 60 parts
SOLSPERSE 32000 (manufactured by The Lubrizol Corporation; dispersant)··· 10 parts

### Preparation of Ink A6

An ink A6 was prepared in the same manner as in Preparation of ink A5, except that in Preparation of ink A5, the dispersion D1C was changed to the dispersion D1M having the same mass as the dispersion D1C.

In the ink A6, the proportion of the polyfunctional polymerizable monomer in the polymerizable compound is 65% by mass.

### Preparation of Ink A7 (Polyfunctional Ratio 65% by Mass, Containing Yellow Pigment)

### Preparation of Dispersion D1Y

The components in the following composition were put in a disperser motor mill M50 (manufactured by Eiger Torrance Limited) and dispersed and mixed together using zirconia beads having a diameter of 0.65 mm at a circumferential speed of 9 m/s for 4 hours, thereby obtaining a dispersion D1Y (yellow pigment dispersion).

-Composition of dispersion D1Y-
NOVOPERM YELLOW H2G (manufactured by Clariant AG; yellow pigment)··· 30 parts
SR9003 (manufactured by Sartomer Company Inc.; polyfunctional radically polymerizable monomer; propoxylated (2) neopentyl glycol diacrylate)···60 parts
SOLSPERSE 32000 (manufactured by The Lubrizol Corporation; dispersant)··· 10 parts

### Preparation of ink A7

An ink A7 was prepared in the same manner as in Preparation of ink A5, except that in Preparation of ink A5, the dispersion D1C was changed to the dispersion D1Y having the same mass as the dispersion D1C.

In the ink A7, the proportion of the polyfunctional polymerizable monomer in the polymerizable compound is 65% by mass.

### Preparation of Ink B

Inks B1 to B4 as an ink B containing an infrared absorbing dye were prepared.

The details will be described below.

### Preparation of Ink B1 (Polyfunctional Ratio 100% By Mass)

### Preparation of Dispersion B1

The components in the following composition were mixed together and dispersed in a beads mill for 3 hours, thereby obtaining a dispersion B1 (infrared absorbing dye dispersion).

-Composition of dispersion B1-
Infrared absorbing dye S-1 (Specific Example S-1 of squarylium dye represented by Formula (1) described above)··· 4 parts
SOLSPERSE 35000 (manufactured by The Lubrizol Corporation; polymer dispersant)··· 5 parts
SOLSPERSE 5000S (manufactured by The Lubrizol Corporation, polymer dispersant)···0.01 parts
SR341 (manufactured by Sartomer Company Inc.: polyfunctional radically

polymerizable monomer; 3-methyl-1,5-pentanediol diacrylate)···91.99 parts

### Preparation of Ink B1

The components in the following composition were mixed together and stirred, thereby obtaining an ink B1.

In the ink B1, the proportion of the polyfunctional polymerizable monomer in the polymerizable compound is 100% by mass.

-Composition of ink B1-
Dispersion B1 described above (infrared absorbing dye dispersion)···25 parts
SR341 (manufactured by Sartomer Company Inc.: polyfunctional radically polymerizable monomer; 3-methyl-1,5-pentanediol diacrylate)···66.8 parts
OMNIRAD (registered trademark) 819 (manufactured by IGM Resins B. V.; radical polymerization initiator; acylphosphine oxide compound)···4 parts
SPEEDCURE (registered trademark) 7010L (manufactured by Lambson Ltd.; colorant sensitizer; thioxanthone-based compound having molecular weight of 1,000 to 2,000)···4 parts
FLORSTAB UV12 (manufactured by Kromachem Ltd; nitroso-based polymerization inhibitor; tris(N-nitroso-N-phenylhydroxylamine) aluminum salt)···0.1 parts

BYK307 (manufactured by BYK-Chemie Japan K.K.; silicone-based surfactant; polyether-modified polysiloxane compound)···0.1 parts

### Preparation of Ink B2 (Polyfunctional Ratio 65% by Mass)

An ink B2 was prepared in the same manner as in Preparation of ink B1 except for following points.

In the ink B2, the proportion of the polyfunctional polymerizable monomer in the polymerizable compound is 65% by mass.

### Difference from Preparation of Ink B1

A part of SR341 (66.8 parts) in the preparation of the ink B1 was replaced with CTFA (cyclic trimethylolpropane formal acrylate; monofunctional radically polymerizable monomer). The amount of CTFA used was adjusted, such that the proportion of the polyfunctional polymerizable monomer in the polymerizable compound contained in the ink was 65% by mass.

### Preparation of Ink B3 (Comparative Ink) (Polyfunctional Ratio 50% By Mass)

An ink B3 (comparative ink) was prepared in the same manner as in Preparation of ink B1 except for following points.

In the ink B3, the proportion of the polyfunctional polymerizable monomer in the polymerizable compound is 50% by mass.

### Difference From Preparation of Ink B1-

A part of SR341 (66.8 parts) in the preparation of the ink B1 was replaced with CTFA (cyclic trimethylolpropane formal acrylate; monofunctional radically polymerizable monomer). The amount of CTFA used was adjusted, such that the proportion of the polyfunctional polymerizable monomer in the polymerizable compound contained in the ink was 50% by mass.

### Preparation of Ink B4 (Polyfunctional Ratio 100% by Mass, using Infrared Absorbing Dye B-40)

An ink B4 was prepared in the same manner as in Preparation of ink B1, except that the infrared absorbing dye S-1 was changed to an infrared absorbing dye S-40 (Specific Example S-40 of the squarylium dye represented by Formula (1) described above) having the same mass as the mass of the infrared absorbing dye S-1.

### Preparation of Ink C

Inks C1 and C2 as the ink C containing a fluorescent substance were prepared.

The details will be described below.

### Preparation of Ink C1 (Polyfunctional Ratio 100% by Mass)

### Preparation of Dispersion C1

The components in the following composition were mixed together and dispersed in a beads mill for 3 hours, thereby obtaining a dispersion C1 (fluorescent substance dispersion).

-Composition of dispersion C1-
Coumarin derivative (specifically, 4-methylumbelliferone) (fluorescent substance)··· 10 parts
SOLSPERSE 35000 (manufactured by The Lubrizol Corporation; polymer dispersant)··· 5 parts
SR341 (manufactured by Sartomer Company Inc.: polyfunctional radically polymerizable monomer; 3-methyl-1,5-pentanediol diacrylate)··· 85 parts

### Preparation of Ink C1

The components in the following composition were mixed together and stirred, thereby obtaining an ink C1.

In the ink C1, the proportion of the polyfunctional polymerizable monomer in the polymerizable compound is 100% by mass.

-Composition of ink C1-
Dispersion C1 described above (fluorescent substance dispersion)··· 50 parts
SR341 (manufactured by Sartomer Company Inc.: polyfunctional radically polymerizable monomer; 3-methyl-1,5-pentanediol diacrylate)··· 41.8 parts
OMNIRAD (registered trademark) 819 (manufactured by IGM Resins B. V.; radical polymerization initiator; acylphosphine oxide compound)··· 4 parts
SPEEDCURE (registered trademark) 7010L (manufactured by Lambson Ltd.; colorant sensitizer; thioxanthone-based compound having molecular weight of 1,000 to 2,000)··· 4 parts
FLORSTAB UV12 (manufactured by Kromachem Ltd; nitroso-based polymerization inhibitor; tris(N-nitroso-N-phenylhydroxylamine) aluminum salt)··· 0.1 parts

BYK307 (manufactured by BYK-Chemie Japan K.K.; silicone-based surfactant; polyether-modified polysiloxane compound)··· 0.1 parts

### Preparation of Ink C2 (Polyfunctional Ratio 65% by Mass)

An ink C2 was prepared in the same manner as in Preparation of ink C1 except for following points.

In the ink C2, the proportion of the polyfunctional polymerizable monomer in the polymerizable compound is 65% by mass.

### Difference From Preparation of Ink C1-

A part of SR341 (41.8 parts) in the preparation of the ink C1 was replaced with CTFA (cyclic trimethylolpropane formal acrylate; monofunctional radically polymerizable monomer). The amount of CTFA used was adjusted, such that the proportion of the polyfunctional polymerizable monomer in the polymerizable compound contained in the ink was 65% by mass.

### Preparation of ink D1C (Cyan Ink)

The components in the following composition were mixed together and stirred, thereby preparing an ink D1C as a cyan ink.

-Composition of ink D1C-
Dispersion D1C described above (cyan pigment dispersion)··· 9.5 parts
SR341 (manufactured by Sartomer Company Inc.: polyfunctional radically polymerizable monomer; 3-methyl-1,5-pentanediol diacrylate)··· 72 parts
SR344 (manufactured by Sartomer Company Inc.: polyfunctional radically polymerizable monomer; polyethylene glycol (400) diacrylate)··· 10 parts
OMNIRAD (registered trademark) 819 (manufactured by IGM Resins B. V.; radical polymerization initiator; acylphosphine oxide compound)··· 4 parts
SPEEDCURE (registered trademark) 7010L (manufactured by Lambson Ltd.; colorant sensitizer; thioxanthone-based compound having molecular weight of 1,000 to 2,000)···4 parts
IRGASTAB (registered trademark) UV-22 (BASF SE; quinone-based polymerization inhibitor;
Poly[oxy(methyl-1,2-ethanediyl)], alpha., .alpha.’, alpha.”-1,2,3-propanetriyltris[.omega.-[(1 -oxo-2-propen-1-yl)oxy]-,
2,6-bis(1,1-dimethylethyl)-4-(phenylenemethylene)cyclohexa-2,5-dien-1-one)···0.26 parts BYK307 (manufactured by BYK-Chemie Japan K.K.; silicone-based surfactant; polyether-modified polysiloxane compound)···0.1 parts

### Preparation of Ink D1M (Magenta Ink)

The components in the following composition were mixed together and stirred, thereby preparing an ink D1M as a magenta ink.

-Composition of ink D1M-
Dispersion D1M described above (magenta pigment dispersion)··· 16 parts
SR341 (manufactured by Sartomer Company Inc.: polyfunctional radically polymerizable monomer; 3-methyl-1,5-pentanediol diacrylate)··· 73.6 parts
SR344 (manufactured by Sartomer Company Inc.: polyfunctional radically polymerizable monomer; polyethylene glycol (400) diacrylate)···2 parts
OMNIRAD (registered trademark) 819 (manufactured by IGM Resins B. V.; radical polymerization initiator; acylphosphine oxide compound)··· 4 parts
SPEEDCURE (registered trademark) 7010L (manufactured by Lambson Ltd.; colorant sensitizer; thioxanthone-based compound having molecular weight of 1,000 to 2,000)···4 parts
IRGASTAB (registered trademark) UV-22 (BASF SE; quinone-based polymerization inhibitor)··· 0.26 parts

BYK307 (manufactured by BYK-Chemie Japan K.K.; silicone-based surfactant; polyether-modified polysiloxane compound)···0.1 parts

### Preparation of Ink D1Y (Yellow Ink)

The components in the following composition were mixed together and stirred, thereby preparing an ink D1Y as a yellow ink.

-Composition of ink D1Y-
Dispersion D1Y described above (yellow pigment dispersion)··· 10.5 parts
SR341 (manufactured by Sartomer Company Inc.: polyfunctional radically polymerizable monomer; 3-methyl-1,5-pentanediol diacrylate)···66.1 parts
SR344 (manufactured by Sartomer Company Inc.: polyfunctional radically polymerizable monomer; polyethylene glycol (400) diacrylate)···15 parts
OMNIRAD (registered trademark) 819 (manufactured by IGM Resins B. V.; radical polymerization initiator; acylphosphine oxide compound)···4 parts
SPEEDCURE (registered trademark) 7010L (manufactured by Lambson Ltd.; colorant sensitizer; thioxanthone-based compound having molecular weight of 1,000 to 2,000)···4 parts
IRGASTAB (registered trademark) UV-22 (BASF SE; quinone-based polymerization inhibitor)···0.26 parts

BYK307 (manufactured by BYK-Chemie Japan K.K.; silicone-based surfactant; polyether-modified polysiloxane compound)···0.1 parts

### Preparation of Printed Article 1

In an ink jet printer “JetPress 540WV” manufactured by FUJIFILM Corporation, the ink A1 was introduced into the closest throttle to a sending portion, the ink D1C was introduced into the second throttle, the ink D1M was introduced into the third throttle, the ink D1Y was introduced into the fourth throttle, the ink B1 was introduced into the fifth throttle, and ink C1 was introduced into the sixth throttle.

As a substrate, TAIKO PET 50 µm (polyethylene terephthalate film manufactured by FUTAMURA CHEMICAL CO., LTD., thickness 50 µm) was mounted on the inkjet printer.

The ink jet printer is activated, and the ink A1 and ink B1 were applied on the substrate in this order at a halftone dot rate of 100%. Then, the ink A1 and the ink B1 applied on the substrate were irradiated with ultraviolet rays such that a composite image consisting of a black image derived from the ink A1 and an infrared absorbing image derived from the ink B1 was recorded. In this way, a printed article 1 comprising a substrate and a composite image consisting of a black image and an infrared absorbing image was obtained.

In the composite image of the printed article 1, the black image was a bar code image and a QR code (registered trademark) image, and the infrared absorbing image was a dot code image (specifically, a screen code manufactured by Apollo Japan Co., Ltd.). In addition, in the composite image, the black image and the infrared absorbing image were arranged such that there is an overlap portion of the black image and the infrared absorbing image in a case where the composite image is seen in a plane view.

During the manufacturing the printed article 1, the image resolution was set to 600 dpi × 600 dpi, and the printing speed (base substrate transportation speed) was set to 50 m/min. An undercoat was not used.

The ultraviolet rays had a peak wavelength of 385 nm. The irradiation energy of the ultraviolet rays was set to 6,600 mJ/cm².

### Evaluation of Printed Article 1

The following evaluation was performed on the composite image (black image + infrared absorbing image) in the printed article 1.

The results are shown in Table 1.

Hereinafter, the infrared absorbing image, the bar code image, the QR code image, and the dot code image will be called an IR image, a bar code, a QR code, and a dot code, respectively.

### Initial Readability of Bar Code (Black Image)

Within the composite image in the printed article 1, 10 sites where the bar code as the black image and the dot code as the IR image (infrared absorbing image) (specifically, a screen code manufactured by Apollo Japan Co., Ltd., the same shall be applied hereinafter) overlapped each other were selected, and an initial bar code reading test was carried out at each site by using a bar code reader of a smartphone (“i-Phone SE” manufactured by Apple Inc.).

Based on the obtained results, the initial bar code readability was evaluated according to the following evaluation standard.

In the following evaluation standard, A is the rank that indicates the best initial bar code readability.

-Evaluation standard-
A: The bar code could be read at all 10 sites.
B: The bar code could be read at 8 or 9 sites out of 10 sites.
C: The bar code could be read at 3 or 7 sites out of 10 sites.
D: The bar code could be read at one or two sites out of 10 sites.
E: There was no site where the bar code could be read among 10 sites.

### Initial QR Code (Black Image) Readability

Within the composite image in the printed article 1, 10 sites where the QR code as the black image and the dot code as the IR image overlapped each other were selected, and an initial QR code reading test was carried out at each site by using a QR code reader of a smartphone (“i-Phone SE” manufactured by Apple Inc.).

Based on the obtained results, the initial QR code readability was evaluated according to the following evaluation standard.

In the following evaluation standard, A is the rank that indicates the best initial QR code readability.

-Evaluation standard-
A: The QR code could be read at all 10 sites.
B: The QR code could be read at 8 or 9 sites out of 10 sites.
C: The QR code could be read at 3 or 7 sites out of 10 sites.
D: The QR code could be read at 1 or 2 sites out of 10 sites.
E: There was no site where the QR code could be read among 10 sites.

### Initial dot code (IR image) Readability

Within the composite image in the printed article 1, 10 sites where the bar code or the QR code as the black image and the dot code as the IR image (that is, a screen code manufactured by Apollo Japan Co., Ltd.) overlapped each other were selected, and an initial dot code reading test was carried out at each site by using a speaking pen manufactured by Apollo Japan Co., Ltd. The initial reading test using the speaking pen is a test relating to IR readability (that is, readability by infrared rays).

Based on the obtained results, the initial dot code readability was evaluated according to the following evaluation standard.

In the following evaluation standard, A is the rank that indicates the best initial dot code readability.

-Evaluation standard-
A: The dot code could be read at all 10 sites.
B: The dot code could be read at 8 or 9 sites out of 10 sites.
C: The dot code could be read at 3 or 7 sites out of 10 sites.
D: The dot code could be read at 1 or 2 sites out of 10 sites.
E: There was no site where the dot code could be read among 10 sites.

### Bar Code (black image) Readability After Rub

The composite image in the printed article 1 was subjected to a 100-reciprocating JSPS friction test under a load of 500 g.

In the middle of and after the JSPS friction test, 10 sites where the bar code as the black image and the dot code as the IR image overlapped each other were selected, and an initial bar code reading test was carried out at each site by using a bar code reader of a smartphone (“i-Phone SE” manufactured by Apple Inc.).

Based on the obtained results, the bar code readability after rub was evaluated according to the following evaluation standard.

In the following evaluation standard, A is the rank that indicates the best bar code readability after rub.

-Evaluation standard-
A: The number of sites where the bar code could be read after a 100-reciprocating friction test is the same as the number of sites where the bar code could be read initially.
B: The number of sites where the bar code could be read after a 50-reciprocating friction test was the same as the number of sites where the bar code could be read initially, but the number of sites where the bar code could be read after a 100-reciprocating friction test was smaller than the number of sites where the bar code could be read initially.
C: The number of sites where the bar code could be read after a 30-reciprocating friction test was the same as the number of sites where the bar code could be read initially, but the number of sites where the bar code could be read after a 50-reciprocating friction test was smaller than the number of sites where the bar code could be read initially.
D: The number of sites where the bar code could be read after a 10-reciprocating friction test was the same as the number of sites where the bar code could be read initially, but the number of sites where the bar code could be read after a 30-reciprocating friction test was smaller than the number of sites where the bar code could be read initially.
E: The number of sites where the bar code could be read after a 10-reciprocating friction test was smaller than the number of sites where the bar code could be read initially.

### QR Code (Black Image) Readability After Rub

The composite image in the printed article 1 was subjected to a 100-reciprocating JSPS friction test under a load of 500 g.

In the middle of and after the JSPS friction test, 10 sites where the QR code as the black image and the dot code as the IR image overlapped each other were selected, and an initial QR code reading test was carried out at each site by using a QR code reader of a smartphone (“i-Phone SE” manufactured by Apple Inc.).

Based on the obtained results, the QR code readability after rub was evaluated according to the same evaluation standard as the evaluation standard for the aforementioned bar code readability after rub.

### Dot Code (IR Image) Readability after Rub

The composite image in the printed article 1 was subjected to a 100-reciprocating JSPS friction test under a load of 500 g.

In the middle of and after the JSPS friction test, 10 sites where the bar code or the QR code as the black image and the dot code as the IR image (that is, a screen code manufactured by Apollo Japan Co., Ltd.) overlapped each other were selected, and a dot code reading test after rub (IR reading test) was carried out at each site by using a speaking pen manufactured by Apollo Japan Co., Ltd.

Based on the obtained results, the dot code readability after rub was evaluated according to the same evaluation standard as the evaluation standard for the aforementioned bar code readability after rub.

### Invisibility of Dot Code (IR Image)

The printed article 1 was given to 10 subjects who did not know that a dot code (screen code) was recorded as an IR image on the printed article 1, and the number of subjects who noticed the presence of the dot code was checked.

Based on the obtained results, the invisibility of the dot code (IR image) was evaluated according to the following evaluation standard.

In the following evaluation standard, A is the rank that indicates the highest invisibility of the dot code (IR image).

-Evaluation standard-
A: None of the 10 subjects noticed the presence of the dot code.
B: One of the 10 subjects noticed the presence of the dot code.
C: Among the 10 subjects, 2 to 5 subjects noticed the presence of the dot code.
D: Among the 10 subjects, 6 or more subjects noticed the presence of the dot code.

### Preparation and Evaluation of Printed Articles 2 to 10

Printed articles 2 to 10 were prepared and evaluated in the same manner as in the preparation and evaluation of the printed article 1, except that the combination of the ink A and the ink B was changed as shown in Table 1.

The results are shown in Table 1.

TABLE 1

| | Ink A | | Ink B | | | Initial readability | | | Readability after rub | | | Invisibility of dot code | Note |
|---|---|---|---|---|---|---|---|---|---|---|---|---|---|
| | No. | Polyfunctional ratio (% by mass) | No. | Polyfunctional ratio (% by mass) | IR dye | I Black image | | IR image | Black image | | IR image | | |
| | | | | | | Bar code | QR code | Dot code (IR readability) | Bar code | QR code | Dot code (IR readability) | | |
| Printed article 1 | A1 | 100 | B1 | 100 | S-1 | A | A | A | A | A | A | A | Example |
| Printed article 2 | A2 | 65 | B2 | 65 | S-1 | A | A | A | A | A | A | A | Example |
| Printed article 3 | A2 | 65 | B3 | 50 | S-1 | A | A | E | A | A | E | A | Comparative example |
| Printed article 4 | A3 | 50 | B2 | 65 | S-1 | E | E | E | E | E | E | A | Comparative example |
| Printed article 5 | A3 | 50 | B3 | 50 | S-1 | E | E | E | E | E | E | A | Comparative example |
| Printed article 6 | A4 | 65 | B2 | 65 | S-1 | A | A | A | A | A | A | A | Example |
| Printed article 7 | A5 | 65 | B2 | 65 | S-1 | A | A | A | A | A | A | A | Example |
| Printed article 8 | A6 | 65 | B2 | 65 | S-1 | A | A | A | A | A | A | A | Example |
| Printed article 9 | A7 | 65 | B2 | 65 | S-1 | A | A | A | A | A | A | A | Example |
| Printed article 10 | A1 | 100 | B4 | 100 | S-40 | A | A | A | A | A | A | A | Example |

As shown in Table 1, the printed article of each example prepared using a combination (that is, an ink set) of the ink A which contains a polymerizable compound, a photopolymerization initiator, and perylene black and in which a polyfunctional ratio (that is, a proportion of a polyfunctional polymerizable monomer contained in the polymerizable compound) is 60% by mass or more, and the ink B which contains a polymerizable compound, a photopolymerization initiator, and an infrared absorbing dye and has a polyfunctional ratio of 60% by mass or more was excellent in the readability of the IR image (dot code) derived from the ink B.

On the other hand, in all of the printed articles of comparative examples in which the polyfunctional ratio of the ink A was less than 60% by mass and the printed articles of comparative examples in which the polyfunctional ratio of the ink B was less than 60% by mass, the IR image readability deteriorated.

### Printed Article 101

A printed article 101 was prepared in the same manner as in the preparation of the printed article 1 except for the following points.

The ink jet printer is activated, and the ink A1, the ink B 1, and the ink C1 were applied on the substrate in this order at a halftone dot rate of 100%. Then, the ink A1, the ink B 1, and the ink C1applied on the substrate were irradiated with ultraviolet rays such that a composite image consisting of a black image derived from the ink A1, an IR image derived from the ink B 1, and an image derived from the ink C1 was recorded. In this way, a printed article 101 comprising a substrate and a composite image consisting of a black image, an IR image, and a fluorescence image was obtained.

In the composite image in the printed article 101, the black image was a bar code image and a QR code (registered trademark) image, the IR image was a dot code image (specifically, a screen code manufactured by Apollo Japan Co., Ltd.), and the fluorescence image was a logo image of FUJIFILM Corporation (hereinafter, also simply called “logo”).

In addition, in the composite image, the black image, the IR image, and the fluorescence image were arranged such that there is an overlap portion of the black image, the IR image, and the fluorescence image in a case where the composite image is seen in a plane view.

### Evaluation of printed Article 101

For the composite image (black image + IR image + fluorescence image) in the printed article 101, the evaluation of initial bar code readability, initial QR code readability, initial dot code readability (IR readability), bar code readability after rub, QR code readability after rub, dot code readability after rub, and invisibility of dot code was performed in the same manner as in the evaluation of the composite image (black image + IR image) in the printed article 1.

Furthermore, for the logo as the fluorescence image, initial readability, readability after rub, and invisibility were evaluated as below.

The results are shown in Table 2.

### Initial Logo (Fluorescence Image) readability

Within the composite image in the printed article 101, 10 sites where the bar code or QR code as the black image, the dot code as the IR image, and the logo (that is, the logo of FUJIFILM Corporation) as the fluorescence image overlap each other were selected and irradiated with black light, and whether the logo could be visually read during the irradiation with the black light was checked.

Based on the obtained results, the initial logo readability (that is, the readability during irradiation with black light; hereinafter, also called “black light readability”) was evaluated according to the following evaluation standard.

In the following evaluation standard, A is the rank that indicates the best initial logo readability.

-Evaluation standard-
A: At all the 10 sites, the logo could be visually confirmed during the irradiation with black light.
B: In at least one site among the 10 sites, the logo could not be visually confirmed during the irradiation with black light.

### Logo (Fluorescence Image) Readability After Rub

The composite image in the printed article 101 was subjected to a 100-reciprocating JSPS friction test under a load of 500 g.

In the middle of and after the JSPS friction test, 10 sites where the bar code as the black image, the dot code as the IR image, and the logo as the fluorescence image overlapped each other were selected and irradiated with black light, and whether the logo could be visually read during the irradiation with black light was checked.

Based on the obtained results, the logo readability after rub was evaluated according to the following evaluation standard.

In the following evaluation standard, A is the rank that indicates the best logo readability after rub.

-Evaluation standard-
A: The number of sites where the logo could be read after a 100-reciprocating friction test is the same as the number of sites where the logo could be read initially.
B: The number of sites where the logo could be read after a 50-reciprocating friction test was the same as the number of sites where the logo could be read initially, but the number of sites where the logo could be read after a 100-reciprocating friction test was smaller than the number of sites where the logo could be read initially.
C: The number of sites where the logo could be read after a 30-reciprocating friction test was the same as the number of sites where the logo could be read initially, but the number of sites where the logo could be read after a 50-reciprocating friction test was smaller than the number of sites where the logo could be read initially.
D: The number of sites where the logo could be read after a 10-reciprocating friction test was the same as the number of sites where the logo could be read initially, but the number of sites where the logo could be read after a 30-reciprocating friction test was smaller than the number of sites where the logo could be read initially.
E: The number of sites where the logo could be read after a 10-reciprocating friction test was smaller than the number of sites where the logo could be read initially.

### Invisibility of Logo (Fluorescence Image)

The printed article 101 was given to 10 subjects who did not know that the logo as a fluorescence image was recorded on the printed article 101, and the number of subjects who noticed the presence of the logo was checked.

Based on the obtained results, the invisibility of the logo (fluorescence image) was evaluated according to the following evaluation standard.

In the following evaluation standard, A is the rank that indicates the highest invisibility of the logo (fluorescence image).

-Evaluation standard-
A: None of the 10 subjects noticed the presence of the logo (fluorescence image).
B: One of the ten subjects noticed the presence of the logo (fluorescence image).
C: Among the 10 subjects, 2 to 5 subjects noticed the presence of the logo (fluorescence image).
D: Among the 10 subjects, 6 or more subjects noticed the presence of the logo (fluorescence image).

### Preparation And Evaluation of Printed Article 102

A printed article 102 was prepared and evaluated in the same manner as in the preparation and evaluation of the printed article 101, except that the combination of the ink A, the ink B, and the ink C (that is, the ink set) was changed as shown in Table 2.

The results are shown in Table 2.

TABLE 2

| | Ink A | I Ink B . | I Ink C | | Initial readability | | | | Readability after rub | | | | Invisibility of dot code | Invisibility of logo | Note |
|---|---|---|---|---|---|---|---|---|---|---|---|---|---|---|---|
| | | | No. | Polyfunctional ratio (% by mass) | Black image | | IR image | Fluorescence image | Black image | | IR image | Fluorescence image | | | |
| | | | | | Bar code | QR code | Dot code (IR readability) | Logo (black light readability) | Bar code | QR code | Dot code (IR readability) | Logo (black light readability) | | | |
| Printed article 101 | A1 | B1 | C1 | 100 | A | A | A | A | A | A | A | A | A | A | Example |
| Printed article 102 | A2 | B2 | C2 | 65 | A | A | A | A | A | A | A | A | A | A | Example |

As shown in Table 2, from the printed articles 101 and 102, the same results as those obtained from the printed articles 1 and 2 were obtained respectively.

Furthermore, in the printed articles 101 and 102, the initial logo readability, the logo readability after rub, and the invisibility of the logo were also excellent.

[Preparation of printed articles 201 to 203]

### Printed Articles 201 to 203 Were Prepared in the Same Manner as in the Preparation of The Printed Article 101 Except for the Following Points.

The ink jet printer is activated, and the ink A1 and the ink D shown in Table 3 [specifically, the ink D1C (printed article 201), the ink D1M (printed article 202), or the ink D1Y (printed article 203)], the ink B 1, and the ink C1 were applied on a substrate in this order.

Then, the ink A1, the ink D, the ink B1, and the ink C1 applied on the substrate was irradiated with ultraviolet rays, such that a composite image was recorded which consisted of a black image derived from the ink A1, a color image derived from the ink D [specifically, a cyan image derived from the ink D1C (printed article 201), a magenta image derived from the ink D1M (printed article 202), or a yellow image (printed article 203) derived from the ink D1Y], an IR image derived from the ink B1, and a fluorescence image derived from the ink C1.

In the composite image, the black image was a bar code image and a QR code (registered trademark) image, the color image was a bar code image and a QR code (registered trademark) image that are superposed on the black image, the IR image was a dot code image (specifically, a screen code manufactured by Apollo Japan Co., Ltd.), and the fluorescence image was a logo image of Fujifilm Corporation (hereinafter, also simply called “logo”).

The ink D1C (printed article 201) was applied at a halftone dot rate of 18%, the ink D1M (printed article 202) was applied at a halftone dot rate of 10%, and the ink D1Y (printed article 203) was applied at a halftone dot rate of 16%. The inks other than these were applied at a halftone dot rate of 100%.

In this way, printed articles 201 to 203 each comprising a substrate and a composite image consisting of a black image, a color image, an IR image, and a fluorescence image were obtained.

The color image is an image that is superposed on the black image and is for adjusting the tint of the black image.

[Evaluation of printed articles 201 to 203]

The same evaluation as the evaluation of the printed article 101 was performed on each of the printed articles 201 to 203.

In the printed articles 201 to 203, each of the bar code image and the QR code image is a composite image in which a black image derived from the ink A and a color image derived from the ink D (that is, the color ink) overlap each other.

The results are shown in Table 3.

TABLE 3

| | Ink A | Ink D | Ink B | Ink C | Initial readability | | | | Readability after rub | | | | Invisibility of dot code | Invisibility of logo | Note |
|---|---|---|---|---|---|---|---|---|---|---|---|---|---|---|---|
| | | | | | Black image + Colored image | | IR image | Fluorescence image | Black image + Colored image | | IR image | Fluorescence image | | | |
| | | | | | Bar code | QR code | Dot code (IR readability) | Logo (black light readability) | Bar code | QR code | Dot code (IR readability) | Logo (black light readability) | | | |
| Printed article 201 | A1 | D1C | B1 | C1 | A | A | A | A | A | A | A | A | A | A | Example |
| Printed article 202 | A1 | DIM | B1 | C1 | A | A | A | A | A | A | A | A | A | A | Example |
| Printed article 203 | A1 | D1Y | B1 | C1 | A | A | A | A | A | A | A | A | A | A | Example |

As shown in Table 3, from the printed articles 201 to 203, the same results as those obtained from the printed article 101 were obtained.

### Printed Article 204 (Comparative Example)

A printed article 204 (comparative example) was prepared in the same manner as in the preparation of the printed article 101 except for the following points.

The aforementioned ink jet printer was activated, and the ink D1C, the ink D1M, the ink D1Y, the ink B 1, and the ink C1 were applied on a substrate at a halftone dot rate of 100%. Then, the ink D1C, the ink D1M, the ink D1Y, the ink B1, and the ink C1applied on the substrate were irradiated with ultraviolet rays, such that a composite image was recorded which consisted of a color image (composite black image) derived from the ink D1C, the ink D1M, and the ink D1Y, an IR image derived from the ink B1, and a fluorescence image derived from the ink C1. In this way, a printed article 204 (comparative example) comprising a substrate and a composite image consisting of a color image, an IR image, and a fluorescence image was obtained.

In the composite image in the printed article 204 (comparative example), the color image was a bar code image and a QR code (registered trademark) image, the IR image was a dot code image (specifically, a screen code manufactured by Apollo Japan Co., Ltd.), and the fluorescence image was the logo of FUJIFILM Corporation.

Regarding the color image, more specifically, the ink D1C, the ink D1M, and the ink D1Y were applied in layers in this order on the same region, such that a color image which is a bar code image and a QR code (registered trademark) image was recorded as a composite black image.

The same evaluation as the evaluation of the printed article 101 was performed on the obtained printed article 204 (printed article).

The results are shown in Table 4.

TABLE 4

| | Ink A | Ink D | Ink B | I Ink C | Initial readability | | | | Readability after rub | | | | Invisibility of dot code | Invisibility of logo | Note |
|---|---|---|---|---|---|---|---|---|---|---|---|---|---|---|---|
| | No. | No. | No. | No. | Composite black image | | IR image | Fluorescence image | Composite black image | | IR image | Fluorescence image | | | |
| | | | | | Bar code | QR code | Dot code (IR readability) | Logo (black light readability) | Bar code | QR code | Dot code (IR readability) | Logo (black light readability) | | | |
| Printed article 204 | Nonuse | D1C →D1M →D1Y | B1 | C1 | E | E | C | A | E | E | C | A | A | A | Comparative example |

As shown in Table 4, in the printed article 204 (printed article), the readability of the bar code and the QR code was insufficient. Presumably, this is because the bar code and the QR code were recorded as a composite black image, the readability of the black image deteriorated.

The entire disclosure of Japanese Patent Application No. 2020-121261, filed Jul. 15, 2020, is incorporated into the present specification by reference. All of documents, patent applications, and technical standards described in the present specification are incorporated into the present specification by reference to approximately the same extent as a case where it is specifically and respectively described that the respective documents, patent applications, and technical standards are incorporated by reference.

1. An ink set comprising:
an ink jet ink A which contains a polymerizable compound, a photopolymerization initiator, and perylene black and in which a proportion of a polyfunctional polymerizable monomer in the contained polymerizable compound is 60% by mass or more; and
an ink jet ink B which contains a polymerizable compound, a photopolymerization initiator, and an infrared absorbing dye and in which a proportion of a polyfunctional polymerizable monomer in the contained polymerizable compound is 60% by mass or more.

2. The ink set according to claim 1,
wherein the infrared absorbing dye includes a squarylium compound.

3. The ink set according to claim 1,
wherein the infrared absorbing dye includes a squarylium compound represented by Formula (1), 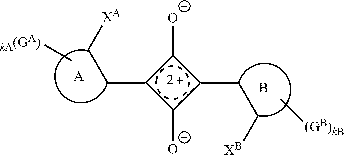
in Formula (1), a ring A and a ring B each independently represent an aromatic ring or a heteroaromatic ring, X^{A} and X^{B} each independently represent a monovalent substituent, G^{A} and G^{B} each independently represent a monovalent substituent, kA represents an integer of 0 to nA, kB represents an integer of 0 to nB, nA represents an integer which is a maximum number of G^{A}’s capable of substituting the ring A, nB represents an integer which is a maximum number of G^{B}’s capable of substituting the ring B, X^{A} and G^{A} or X^{B} and G^{B} may be bonded to each other to form a ring, and in a case where there is a plurality of G^{A}’s and a plurality of G^{B}’s, the plurality of G^{A}’s bonded to the ring A may be bonded to each other to form a ring and the plurality of G^{B}’s bonded to the ring B may be bonded to each other to form a ring.

4. The ink set according to claim 1,
wherein the ink jet ink A further contains at least one pigment selected from the group consisting of a cyan pigment, a magenta pigment, and a yellow pigment.

5. The ink set according to claim 1, further comprising:
an ink jet ink C which contains a polymerizable compound, a photopolymerization initiator, and a fluorescent substance and in which a proportion of a polyfunctional polymerizable monomer in the contained polymerizable compound is 60% by mass or more.

6. A printed article comprising:
a substrate; and
a composite image that is disposed on the substrate and includes a black image and an infrared absorbing image including an overlap portion where the black image and the infrared absorbing image overlap each other in a plane view,
wherein the black image is a cured substance of an ink jet ink A which contains a polymerizable compound, a photopolymerization initiator, and perylene black and in which a proportion of a polyfunctional polymerizable monomer in the contained polymerizable compound is 60% by mass or more, and
the infrared absorbing image is a cured substance of an ink jet ink B which contains a polymerizable compound, a photopolymerization initiator, and an infrared absorbing dye and in which a proportion of a polyfunctional polymerizable monomer in the contained polymerizable compound is 60% by mass or more.

7. The printed article according to claim 6,
wherein the infrared absorbing dye includes a squarylium compound.

8. The printed article according to claim 6,
wherein the infrared absorbing dye includes a squarylium compound represented by Formula (1), 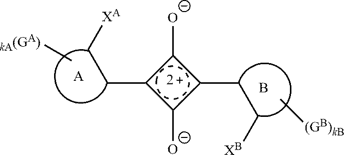
in Formula (1), a ring A and a ring B each independently represent an aromatic ring or a heteroaromatic ring, X^{A} and X^{B} each independently represent a monovalent substituent, G^{A} and G^{B} each independently represent a monovalent substituent, kA represents an integer of 0 to nA, kB represents an integer of 0 to nB, nA represents an integer which is a maximum number of G^{A}’s capable of substituting the ring A, nB represents an integer which is a maximum number of G^{B}’s capable of substituting the ring B, X^{A} and G^{A} or X^{B} and G^{B} may be bonded to each other to form a ring, and in a case where there is a plurality of G^{A}’s and a plurality of G^{B}’s, the plurality of G^{A}’s bonded to the ring A may be bonded to each other to form a ring and the plurality of G^{B}’s bonded to the ring B may be bonded to each other to form a ring.

9. The printed article according to claim 6,
wherein the ink jet ink A further contains at least one pigment selected from the group consisting of a cyan pigment, a magenta pigment, and a yellow pigment.

10. The printed article according to claim 6,
wherein the black image is at least one of a bar code image or a QR code (registered trademark) image, and
the infrared absorbing image is a dot code image.

11. The printed article according to claim 6,
wherein the composite image further includes at least one color image selected from the group consisting of a cyan image that overlaps the black image in a plane view, a magenta image that overlaps the black image in a plane view, and a yellow image that overlaps the black image in a plane view.

12. The printed article according to claim 6,
wherein the composite image further includes a fluorescence image that overlaps the overlap portion in a plane view, and
the fluorescence image is a cured substance of an ink jet ink C which contains a polymerizable compound, a photopolymerization initiator, and a fluorescent substance and in which a proportion of a polyfunctional polymerizable monomer in the contained polymerizable compound is 60% by mass or more.
